(19) United States
(12) Patent Application Publication
(10) Pub. No.: US 2024/0257295 A1
(43) Pub. Date: Aug. 1, 2024

(54) SYSTEM, DEVICES AND/OR PROCESSES FOR PROCESSING IMAGE SIGNAL VALUES

(71) Applicant: Arm Limited, Cambridge (GB)

(72) Inventors: Maxim Novikov, Manchester (GB); Yanxiang Wang, Manchester (GB); Tarush Bansal, Cambridge (GB)

(21) Appl. No.: 18/161,743

(22) Filed: Jan. 30, 2023

(51) Int. Cl. G06T 1/60; G06T 7/90

(52) U.S. Cl. CPC G06T 1/60; G06T 7/90; G06T 2207/10024; G06T 2207/20081; G06T 2207/20084

(57) ABSTRACT

Example methods, apparatuses, and/or articles of manufacture are disclosed that may be implemented, in whole or in part, in techniques to process image signal intensity values sampled from a multi color channel imaging device. In particular, such techniques may comprise application of convolution operations with kernel coefficients selected from a set of coefficient values such that the same coefficient value is to be applied to image signal intensity values of multiple pixel locations in an image frame.

### BACKGROUND

### 1. Field

The present disclosure relates generally to image processing devices.

### 2. Information

An imaging device formed on or in combination with an integrated circuit device typically includes an array of pixels formed by filters disposed over photo detectors (e.g., photo diodes formed in a complementary metal oxide semiconductor device) in a Bayer pattern. Such a Bayer pattern typically implements three color channels for red, blue and green visible light. Image signal intensity values associated with pixel locations in an image frame obtained from an imaging device may be further processed by application of one or more kernels in convolution operations. Kernels may be applied in convolution operations to image signal intensity values defined for color channels in different color spaces (e.g., RGB, YUV or other color spaces), as well as to features defined in feature maps of machine-learning/convolution neural network filtering operations, for example.

### BRIEF DESCRIPTION OF THE DRAWINGS

Claimed subject matter is particularly pointed out and distinctly claimed in the concluding portion of the specification. However, both as to organization and/or method of operation, together with objects, features, and/or advantages thereof, it may best be understood by reference to the following detailed description if read with the accompanying drawings in which:

FIG. 1A is a schematic diagram of an imaging device that defines four color channels including an infrared channel according to an embodiment;

FIGS. 1B through 1F are schematic diagrams of an imaging device that defines three color channels in a so-called Bayer, according to an embodiment;

FIG. 2 is a schematic diagram showing a technique of processing image signals including applying a convolution operation, according to an embodiment;

FIG. 3 is a schematic diagram showing a technique of processing image signals including applying a convolution operation, according to an embodiment;

FIG. 4 is a schematic diagram showing a technique of processing image signals including applying a convolution operation according to further examples, according to an embodiment;

FIG. 5 is a schematic diagram showing a method of processing image signals including applying a convolution operation according to further examples, according to an embodiment;

FIGS. 6A and 6B are schematic diagrams showing a mapping of kernel coefficients to pixel locations for a convolution operation, according to an embodiment;

FIGS. 7A, 7B, 7C and 8 are schematic diagrams showing mapping kernel coefficients to pixel locations for convolution operations, according to embodiments;

FIG. 9A is diagram showing a mapping of ranges or bins to kernel coefficients of different sets of kernel coefficients for multiple color channels, according to embodiments;

FIG. 9B is a flow diagram of a process to convolve image signal intensity values with kernel coefficients, according to an embodiment;

FIGS. 9C and 9D are flow diagrams of a process to pre-prepare image signal intensity values for one or more convolution operations, according to an embodiment;

FIG. 10 is a flow diagram of a technique of processing image signals including applying a further convolution operation, according to an embodiment;

FIG. 11 is a flow diagram of a technique for processing image signal intensity values including applying a further convolution operation, according to an embodiment;

FIG. 12 is a flow diagram of a pipeline technique for processing an image, according to an embodiment; and

FIG. 13 is a schematic diagram of a computing system, according to an embodiment.

Reference is made in the following detailed description to accompanying drawings, which form a part hereof, wherein like numerals may designate like parts throughout that are corresponding and/or analogous. It will be appreciated that the figures have not necessarily been drawn to scale, such as for simplicity and/or clarity of illustration. For example, dimensions of some aspects may be exaggerated relative to others. Further, it is to be understood that other embodiments may be utilized. Furthermore, structural and/or other changes may be made without departing from claimed subject matter. References throughout this specification to “claimed subject matter” refer to subject matter intended to be covered by one or more claims, or any portion thereof, and are not necessarily intended to refer to a complete claim set, to a particular combination of claim sets (e.g., method claims, apparatus claims, etc.), or to a particular claim. It should also be noted that directions and/or references, for example, such as up, down, top, bottom, and so on, may be used to facilitate discussion of drawings and are not intended to restrict application of claimed subject matter. Therefore, the following detailed description is not to be taken to limit claimed subject matter and/or equivalents.

### DETAILED DESCRIPTION

References throughout this specification to one implementation, an implementation, one embodiment, an embodiment, and/or the like means that a particular feature, structure, characteristic, and/or the like described in relation to a particular implementation and/or embodiment is included in at least one implementation and/or embodiment of claimed subject matter. Thus, appearances of such phrases, for example, in various places throughout this specification are not necessarily intended to refer to the same implementation and/or embodiment or to any one particular implementation and/or embodiment. Furthermore, it is to be understood that particular features, structures, characteristics, and/or the like described are capable of being combined in various ways in one or more implementations and/or embodiments and, therefore, are within intended claim scope. In general, of course, as has always been the case for the specification of a patent application, these and other issues have a potential to vary in a particular context of usage. In other words, throughout the disclosure, particular context of description and/or usage provides helpful guidance regarding reasonable inferences to be drawn; however, likewise, “in this context” in general without further qualification refers at least to the context of the present patent application.

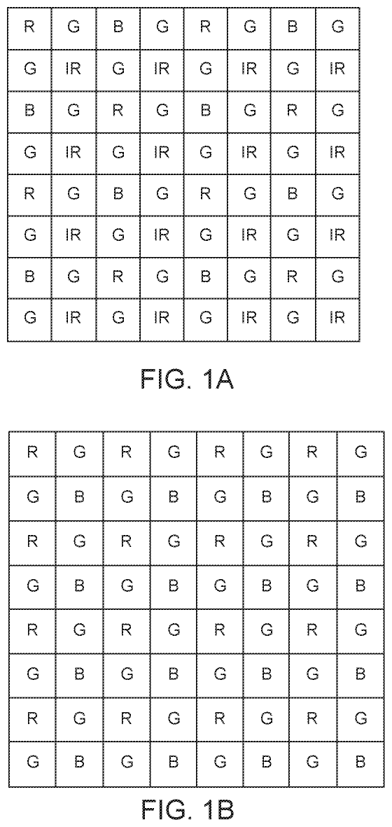

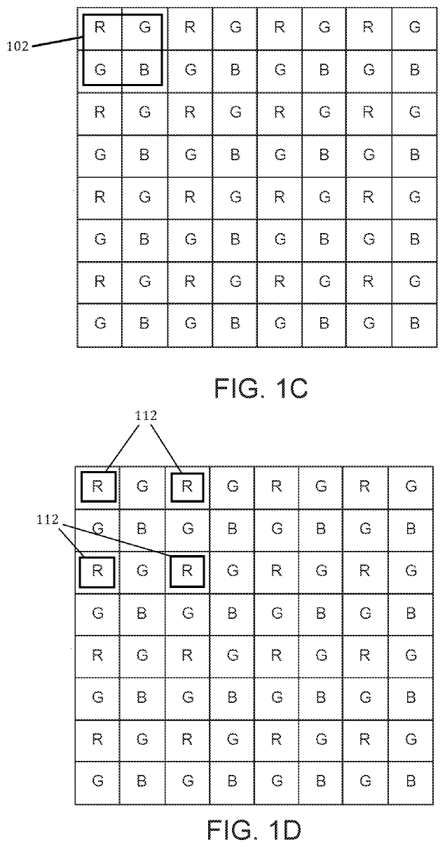

Imaging devices formed in integrated circuit devices may include a substrate formed as a complementary metal oxide semiconductor (CMOS) device having formed thereon an array of photodiodes that are responsive to impinging light energy. In one embodiment as shown in FIG. 1B, light filters or “masks” may be formed over such photodiodes to form red, blue and green pixels of a so-called Bayer pattern pixel array. In an embodiment, energy collected at such photodiodes may be sampled as voltage and/or current samples that express and/or represent an intensity of light of particular color frequency bands at particular pixel locations over an exposure interval (e.g., frame interval).

Sensitivity of such a three-color channel imaging device may be limited to detection of visible light in red, blue and green bands. Accordingly, such a three-color channel imaging device may have limited effectiveness in night and/or low lit environments. According to an embodiment, a Bayer pattern imaging device may be modified to include pixels dedicated to detection of infrared light to implement a fourth color channel of invisible light energy as shown in FIG. 1A. Such an imaging device may comprise any one of a number of commercially available imaging devices such as, for example, the Omnivision OV4682 having a 2×2 RGBIr pattern, Omnivision OV2744 or OnSemi AR0237 having a 4×4 RGBIr pattern. In a particular implementation, light energy detected in these four color channels for red, blue, green and infrared pixels may be processed in such a manner to support imaging based on visible light as well as to support applications that employ infrared detection in non-visible bands. In one particular example, image pixel samples obtained from a four-color channel pixel array (e.g., as shown in FIG. 1A) may be transformed to express image pixel samples in an arrangement according to a three-channel Bayer pattern. This may enable use of legacy processing techniques to process image pixel samples obtained from a four-color channel pixel array for visible light imaging.

In this context, a “kernel” as referred to herein means a set of organized parameters of a convolution operation to be applied to one or more image signal intensity values expressing an image (or a portion of an image), such as image signal intensity values of a color channel associated with pixel locations in the image, to impart a particular intended effect to the image. Such an intended effect may comprise, for example, blurring, interpolating/demosaicing, sharpening, embossing, feature detection/extraction (e.g., edge detection), just to provide a few examples. In a particular implementation, a kernel may comprise an ordered array of values (e.g., coefficients in an integer or floating point format) tailored for application to image signal intensity values of a particular dimensionality such as dimensions corresponding to color intensity values and/or pixel location. According to an embodiment, a convolution (e.g., filtering) operation for application of a kernel to signal intensity values of an image may be implemented according to expression (1) as follows:

$$g ( {C}_{out} , x , y ) = ω * f ( {C}_{i n} , x , y ) = {\sum }_{d c ∈ {C}_{s}} \{ {\sum }_{dx = - a}^{a} {\sum }_{dy = - b}^{b} ω ( dx , dy , d c ) f [ d c , ( x + dx ) , ( y + dy ) ] \} \qquad ( 1 )$$

where:
f(Cᵢₙ,x,y) are image signal intensity values for input channel Cᵢₙ to represent an original image at pixel locations x,y of the original image;
w is an expression of a kernel defined over a range −a≤dx≤a and −b≤dy≤b;
g(Cₒᵤₜ,x,y) are image signal intensity values for an output channel Cₒᵤₜ to represent an image at pixel locations x,y processed according to kernel ω; and
Cₛ is a subset of input channels including one or more input channels.

While ω as used in expression (1) is defined above for a symmetric range for −a≤ dx≤ a and −b≤dy≤ b, in other implementations ω may defined for an asymmetric range such as, for example, 0≤ dx≤ a and 0≤ dy≤ b.

According to an embodiment, a convolution operation according to expression (1) may be applied separately to image signal intensity values of particular individual color channels Cᵢₙ (e.g., red, green and blue color channels). While particular examples of convolution operations described herein include convolution operations applied to two-dimensional signals with multiple channels, claimed subject matter is not limited to such two-dimensional signals. For example, it should be understood that convolution operations described herein may be applied to one-dimensional signals (e.g., an audio signal) and/or signals having three or more dimensions (with greater or fewer channels) without loss of generality.

As may be appreciated, processing images using convolution operations in real-time applications may consume significant computing resources to, for example, execute multiplication operations to apply kernel coefficients to image signal intensity values, kernel coefficients, store image signal intensity values to be processed in convolution operations and/or store a set of full-granularity kernel coefficients.

In one embodiment, applying a convolution operation may include obtaining a sum of image signal intensity values of the plurality that correspond to a common coefficient value. Such a convolution operation may then include multiplying the sum by the common coefficient value. This approach may reduce a number of multiplication operations to execute such a convolution operation. As such, a number of multipliers in circuitry for an image processing system to perform a convolution operation may be reduced. This approach may also reduce an amount of storage memory consumed by an image processing system to perform convolution operations because fewer coefficients of the kernel require storage. This approach can therefore improve the efficiency with which an image processing system performs convolution operations.

In the example convolution of expression (1), an output image signal intensity value for an output pixel location x,y is computed based on application of kernel coefficients to input image signal intensity values for pixels which neighbor output pixel location x,y. In a convolution operation, it may be observed that an impact of granularity of kernel coefficients applied to an image signal intensity value of a particular pixel location may diminish the greater particular pixel location is offset from output pixel location x,y. In a particular implementation, the kernel coefficients to be applied to image signal intensity values for pixels in a region of the image frame may be selected from a discrete set of coefficient values. The same coefficient value selected from the set of coefficient values may be applied to image signal intensity values of multiple pixel locations in the region based, at least in part, a location of the region relative to the output pixel location. For example, convolving image signal intensity values for multiple pixels in a region with the same coefficient value (e.g., lower granularity coefficient) may not significantly degrade convolution accuracy if the region is significantly offset from the output pixel location. Here, convolving the image signal intensity values of pixels in the region may comprise multiplying a sum of the image signal intensity values of the pixels in the region by the selected kernel coefficient.

As shown by expression (1), kernel coefficients are applied to image signal intensity values of multiple pixel locations to map to an output image signal intensity value of a single output pixel location x,y. There may be separable kernels, sparse kernels, etc. It may be observed that an importance of an exact location of a pixel for an input image signal intensity value may be greater towards the center of the kernel (e.g., output pixel location x,y). In one technique, kernel coefficients may be applied to image signal intensity values sampled more densely towards the middle and more sparsely the further from the center of the kernel. This may have an advantage of a large receptive field and smaller computational costs. In another technique, kernel coefficients offset from an output pixel location may be mapped to a single coefficient value (e.g., combined by averaging). Averaging coefficients of a kernel may improve robustness and performance of such a kernel for denoising applications as well as reducing a number of delayed lines in streaming processing.

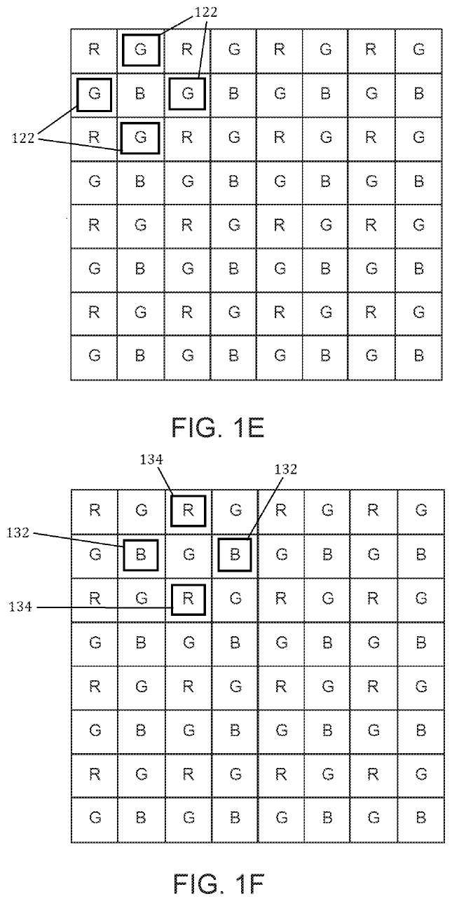

FIG. 2 is a schematic diagram showing a technique 100 of processing image signals 102 including applying a convolution operation 104. Technique 100 includes obtaining image signals 102, image signals 102 including a plurality of image signal intensity values i₁₁-i₅₅. In FIG. 2, the plurality of image signal intensity values i₁₁-i₅₅ are arranged as a 5×5 array, each image signal intensity value corresponding to a pixel location of an image represented by image signals 102. The plurality of image signal intensity values i₁₁-i₅₅ may represent at least a portion of an image such that the image includes an array of image signal intensity values which is larger than a 5×5 array. The plurality of image signal intensity values i₁₁-i₅₅ may, for example, be referred to as a plurality of pixel intensity values.

In technique 100 (FIG. 2), image signals 102 may be processed, thereby generating output signals 106. In this example, output signals 108 include an output signals value O₁. Processing the image signals 102 may include applying convolution operation 104 to the plurality of image signal intensity values i₁₁-i₅₅ using a kernel 108. Kernel 108 comprises a plurality of coefficients a-y. A kernel may sometimes be referred to as a “filter kernel” or a “filter” and coefficients may sometimes be referred to as “weights”. In some examples, the plurality of coefficients a-y may be predetermined specifically for an image processing purpose to be carried out by the convolution operation 104, such as edge detection or demosaicing for example. In other examples, such as in cases where the convolution operation 104 may be applied to implement at least part of a neural network architecture, the plurality of coefficients a-y may be learned during a training phase used to define parameters of a neural network architecture (which is for example a trained neural network architecture). In the example of FIG. 2, each of the plurality of coefficients a-y may have a different respective coefficient value, e.g., a different numerical value.

In technique 100 (FIG. 2), according to an embodiment, performing convolution operation 104 may include performing a multiply-accumulate (MAC) operation (e.g., according to expression (1)) in which each coefficient of the plurality of coefficients a-y is multiplied by a corresponding image signal intensity value of the plurality of image signal intensity values i₁₁-i₅₅, and the resulting products are summed to generate the output signals value O₁. It is to be understood that in examples where plurality of image signal intensity values i₁₁-i₅₅ represents a portion of an image represented by the image signals 102, an output signals array comprising a plurality of output signal values may be generated by performing a MAC operation for each of a predetermined set of pixel locations. In an example, pixel locations in such a predetermined set of pixel locations may be separated by a fixed number of image signal intensity values, referred to as a stride, in plane directions of an array.

In the presently illustrated embodiment, convolution operation 104 may involve 25 MAC operations to derive output signal value O₁. On this basis, applying the convolution operation 104 may entail an image processing system performing 25 multiplication operations, that is, a multiplication of each coefficient of the plurality of coefficients a-y with a corresponding image signal intensity value of the plurality of image signal intensity values i₁₁-i₅₅, e.g. with the same relative position in the portion of the image represented by the image signals 102 and in the kernel 108. In FIG. 2, for example, applying convolution operation 104 may involve multiplying image signal intensity value i₁₁ by coefficient a because the image signal intensity data value i₁₁ and coefficient a are each located in the same relative position (the top left position) in the portion of the image represented by the image signals 102 and in the kernel 108, respectively. Technique 100 may use 25 multipliers to perform convolution operation 104, to multiply each of the plurality of coefficients a-y with a corresponding image signal intensity value i₁₁-i₅₅. Technique 100 may entail storage of 25 coefficients of the plurality of coefficients a-y.

Examples described herein relate to improving efficiency with which an image processing system performs convolution operations by reducing a number of multipliers and an amount of storage space required to generate an output signal data value. Although some examples herein are explained throughout with reference to a 5×5 kernel, it is to be understood that the examples described herein may be used with a kernel of various other sizes, shapes and/or dimensionalities. In other example implementations, kernel sizes of 7×7 or larger may be implemented without deviating from claimed subject matter.

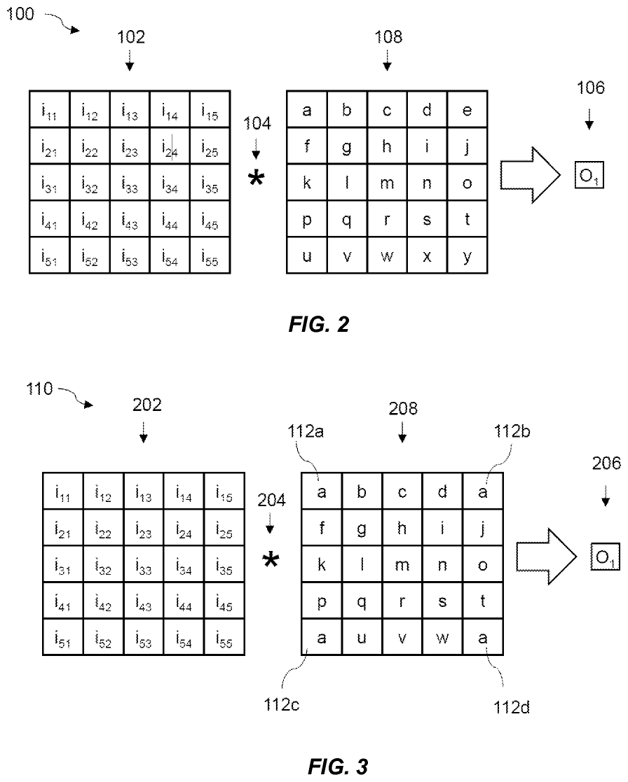

FIG. 3 is a schematic diagram showing a technique 110 of processing image signals 202 including applying a convolution operation 204 using a kernel 208. Features of FIG. 3 similar to corresponding features of FIG. 2 are labelled with the same reference numeral but incremented by 100; corresponding descriptions are to be taken to apply.

In this example, technique 110 may include obtaining image signals 202 which includes the plurality of image signal intensity values i₁₁-i₅₅. In technique 110 of FIG. 3, image signals 202 are processed, thereby generating output signals 206 which includes output signal value O₁. Processing image signals 202 may include applying a convolution operation 204 to the plurality of image signal intensity values i₁₁-i₅₅ using kernel 208, which includes a plurality of coefficients. In this example, coefficients 112a-112d of the plurality of coefficients each have a common coefficient value a. The coefficient values (in this case, that each of the coefficients 112a-112d have the same coefficient value a) may be predetermined (e.g., pre-selected) or may alternatively be determined based on processing of other data. For example, in cases where the convolution operation 204 is applied to implement at least part of a neural network architecture, the coefficient values of the coefficients 112a-112d may be learned during a machine learning training phase of a machine learning process.

Applying convolution operation 204 may include obtaining a sum of image signal intensity values of the plurality of image signal intensity values i₁₁-i₅₅ that correspond respectively to the coefficients 112a-112d of the plurality of coefficients that each have the common coefficient value a. In the example of FIG. 3, this corresponds to obtaining a sum of the image signal intensity values i₁₁, i₁₅, i₅₁ and i₅₅. Convolution operation 204 may also include multiplying the sum by the common coefficient value a. In technique 110, applying convolution operation 204 may also include multiplication of each remaining coefficient b-w with the corresponding image signal intensity value of the plurality of image signal intensity values i₁₁-i₅₅. Resulting products may be summed together, and further added to the result of multiplying the sum of the image signal intensity values i₁₁, i₁₅, i₅₁ and i₅₅ by the common coefficient value a, to generate output signal value O₁.

In this way, the number of multiplication operations involved in technique 110 of FIG. 3 is 22, which is fewer than the 25 multiplication operations involved in technique 100 (FIG. 2). In addition, an example image processing system for performing the technique 110 of may entail storage for only 22 coefficients rather than 25 coefficients. As explained above, this reduces a number of multipliers and an amount of storage space for an image processing system to generate the output signal value O₁, thereby improving the efficiency with which an image processing system performs convolution operations.

In some examples, a convolution operation may be applied to implement at least part of a neural network architecture. For example, convolution operation 204 in FIG. 3 may be applied to implement at least part of a convolutional neural network (CNN) architecture, which can be used to efficiently analyze images e.g. for image classification. A CNN architecture may include multiple convolutional layers, each of which generates a feature map via convolutions between an array of image signal intensity values and one or more kernels. Each feature map may contain multiple elements, where each element is computed via a series of MAC operations between image signal intensity values and respective coefficients of a kernel. Neural network architectures may also comprise other layer types, for example, Fully Connected (FC) layers, deconvolution layers, recurrent layers, and so forth.

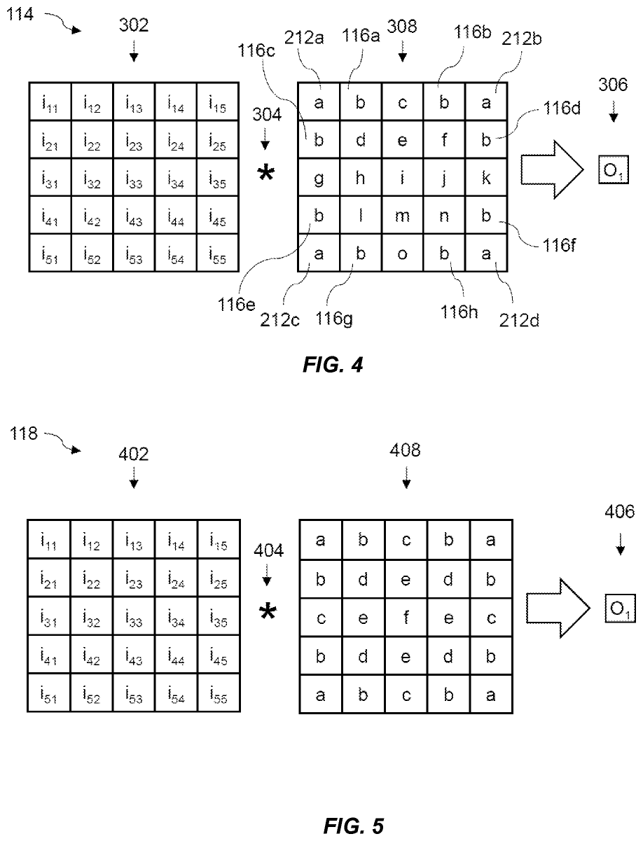

FIG. 4 is a schematic diagram showing technique 114 of processing image signals 302 including applying a convolution operation 304 using a kernel 308. Features of FIG. 4 similar to corresponding features of FIG. 3 are labelled with the same reference numeral but incremented by 100; corresponding descriptions are to be taken to apply. In this example, common coefficient value a is a first common coefficient value and the sum of image signal intensity values i₁₁, i₁₅, i₅₁ and i₅₅ is a first sum. In addition, further coefficients 116a-116h of the plurality of coefficients may each have a second common coefficient value b, which is different from the first common coefficient value a.

In technique 114 (FIG. 4), image signals 302 may be processed, thereby generating output signals 306 which includes output signal value O₁. Processing image signals 302 may include applying convolution operation 304 to the plurality of image signal intensity values i₁₁-i₅₅ using the kernel 308. In technique 114, applying convolution operation 304 may include obtaining a second sum of image signal intensity values of plurality of image signal intensity values i₁₁-i₅₅ that correspond respectively to coefficients. In the example of FIG. 4, this may correspond to obtaining a sum of the image signal intensity values 112, 114, 121, 125, 141, 145, 152 and 154 as the second sum. Convolution operation 304 may also include multiplying the second sum by the second common coefficient value b. In technique 114 (FIG. 4), applying convolution operation 304 may also include multiplication of each remaining coefficient c-o with the corresponding image signal intensity value of the plurality of image signal intensity values i₁₁-i₅₅. Resulting products may be summed together, and further added to the result of multiplying the sum of the image signal intensity values i₁₁, i₁₅, i₅₁ and i₅₅ by the common coefficient value a, and the result of multiplying the second sum by the second common coefficient value b, to generate the output signal value O₁.

In this manner, a number of multiplication operations involved in technique 114 is 15, showing a further reduction compared to the 25 multiplication operations involved in technique 100 (FIG. 2). In addition, an image processing system for performing technique 114 may entail storage for only 15 coefficients rather than 25 coefficients. As explained above, this may further reduce a number of multipliers and an amount of storage space for an image processing system to generate the output signal value O₁, thereby further improving efficiency with which an image processing system performs convolution operations.

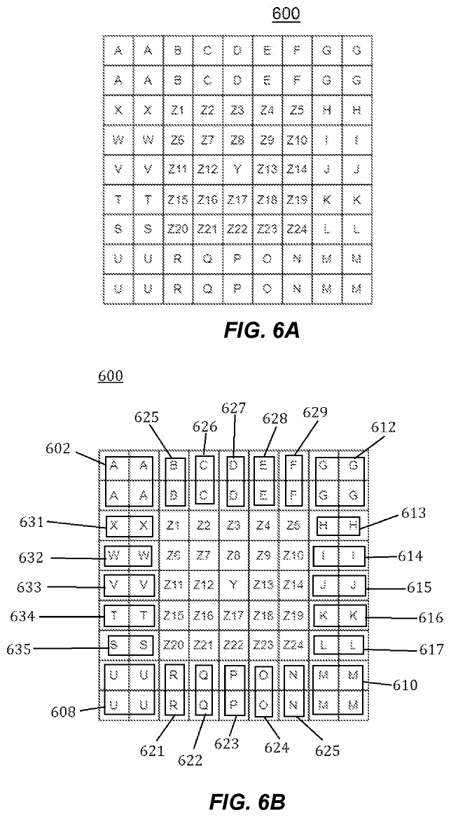

FIG. 5 is a schematic diagram showing technique 118 of processing image signals 402 thereby generating output signals 406, the processing including applying a convolution operation 404 using a kernel 408. Features of FIG. 5 similar to corresponding features of FIG. 4 are labelled with the same reference numeral but incremented by 100; corresponding descriptions are taken to apply.

In this example, kernel 408 is symmetric. Such a symmetric kernel may be described generally as a kernel having at least one line of reflective symmetry, such as a kernel comprising an array of coefficients. Each coefficient may be given by K_{i,j}, where i is a row number of the array of coefficients and j is a column number of the array of coefficients, for which K_{i,j}=K_{i,j}. This expression may represent one line of reflective symmetry of the kernel. However, kernel 408 in this particular example may include four such lines of reflective symmetry such that coefficients K_{i,j} of the kernel 408 also satisfy K_{i,j}=K_{(N-j+1),(N-i+1)} and K_{i,j}=K_{(N-i+1),j} where N represents the size of the kernel 408 (i.e. N=5 in this case). In one particular implementation, a predetermined constraint on kernel 408 to be symmetric may be implemented using the three expressions above for coefficients K_{i,j} (e.g., with the coefficient values pre-selected so that the kernel 408 is symmetric). In another particular implementation, there may be no such predetermined constraint on kernel 408. For example, in cases where convolution operation 404 is applied to implement at least part of a neural network architecture, coefficient values of kernel 408 may be learned during a machine learning training phase.

It can be seen that the kernel 408 may be represented by six common coefficient values a, b, c, d, e and f, each of which is different from one another. Applying techniques described above with reference to FIG. 3 and FIG. 4, the number of multiplication operations involved in technique 118 is six, showing an even further reduction compared to the 25 multiplication operations involved in technique. In addition, an image processing system for performing technique 118 may entail storage for only six coefficients rather than 25 coefficients. As explained above, this may further reduce a number of multipliers and an amount of storage space used for an image processing system to generate output signal value O₁, thereby yet further improving efficiency with which an image processing system may perform convolution operations. It is to be understood that in other examples, not all three expressions may be used to define coefficients K_{i,j} of the kernel, and hence a kernel according to examples described herein may include at least one, but less than four lines of reflective symmetry. This may still reduce a number of multiplication operations required to apply the convolution operation, and the storage usage for an image processing system as compared to technique 100 (FIG. 2).

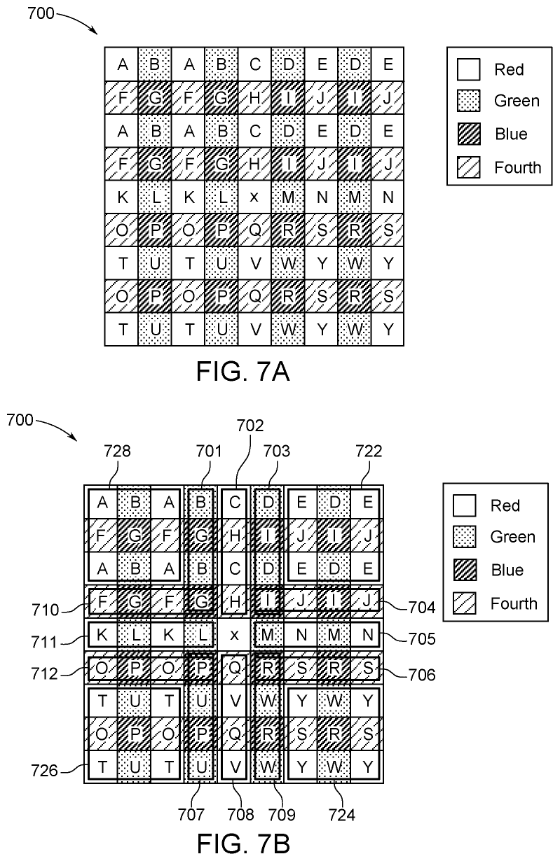

As pointed out above, an impact of granularity of kernel coefficients applied to an image signal intensity value of a particular pixel location in a convolution operation according to expression (1) may diminish the greater particular pixel location is offset from output pixel location x,y. In the particular example implementation of FIGS. 6A and 6B, a kernel coefficient Y may be applied to an image signal intensity value at an output pixel location. In a 5×5 region centered at the output pixel location, kernel coefficients Z1 though Z24 may be applied as unique full-granularity kernel coefficients. Kernel coefficients to be applied to image signal values of remaining pixel locations may be selected from a set of kernel coefficients A through W, which may be of a reduced granularity. As such, application of a kernel to process image signal intensity values of 81 pixels locations in FIGS. 6A and 6B may be accomplished with storage of only 48 kernel coefficients (Z1 though Z24 and A through W) and an associated 48 multiplication operations.

As shown in FIG. 6B, at a vertical periphery of embodiment 600 from a center region at which full-granularity kernel coefficients are applied, kernel coefficient values at multiple pixel locations may be mapped to a single coefficient value B, C, D, E, F, R, Q, P, O or N. This is shown by example at regions 620 through 629 at such a vertical periphery. As shown, single coefficient value R may be uniformly applied in a vertical direction in region 620, single coefficient value Q may be uniformly applied in a vertical direction in region 621, single coefficient value P may be uniformly applied in a vertical direction in region 622, single coefficient value O may be uniformly applied in a vertical direction in region 623, single coefficient value N may be uniformly applied in a vertical direction in region 624, single coefficient value B may be uniformly applied in a vertical direction in region 625, single coefficient value C may be uniformly applied in a vertical direction in region 626, single coefficient value D may be uniformly applied in a vertical direction in region 627, single coefficient value E may be uniformly applied in a vertical direction in region 628 and single coefficient value F may be uniformly applied in a vertical direction in region 629.

Similarly, at a lateral periphery of embodiment 600 from a center region at which full-granularity kernel coefficients are applied, kernel coefficient values at multiple pixel locations may be mapped to a single coefficient value H, I, J, K, L, S, T, V, W or X. This is shown by example at regions 613 through 617 and 631 through 635 at such a lateral periphery. As shown, single coefficient value H may be uniformly applied in a horizontal direction in region 613, single coefficient value I may be uniformly applied in a horizontal direction in region 614, single coefficient value J may be uniformly applied in a horizontal direction in region 615, single coefficient value K may be uniformly applied in a horizontal direction in region 616, single coefficient value L may be uniformly applied in a horizontal direction in region 617, single coefficient value X may be uniformly applied in a horizontal direction in region 631, single coefficient value W may be uniformly applied in a horizontal direction in region 632, single coefficient value V may be uniformly applied in a horizontal direction in region 633, single coefficient value T may be uniformly applied in a horizontal direction in region 634 and single coefficient value S may be uniformly applied in a horizontal direction in region 635.

At a region both at a lateral periphery and a vertical periphery of embodiment 600 from a center region, kernel coefficient values at all pixel locations may be mapped to a single coefficient value A, G, M or U. As shown, a single coefficient value A may be applied at all pixel locations in region 602 that is in both a lateral and vertical periphery. Also, a single coefficient value G may be applied at all pixel locations in region 612 that is in both a lateral and vertical periphery. Also, a single coefficient value M may be applied at all pixel locations in region 610 that is in both a lateral and vertical periphery. Also, a single coefficient value U may be applied at all pixel locations in region 608 that is in both a lateral and vertical periphery.

As may be observed from embodiment 600, kernel coefficients to be applied to image signal intensity values of pixels in regions 620 through 629 at a vertical periphery have reduced granularity (e.g., by combining/averaging to a single kernel coefficient value) in a vertical direction. In a horizontal direction in regions 620 through 629, however, kernel coefficients are applied with greater granularity (e.g., full granularity). Likewise, kernel coefficients to be applied to image signal intensity values of pixels in regions 613 through 617 and 631 through 635 in regions at a lateral periphery have reduced granularity (e.g., by combining/averaging to a single uniform value) in a horizontal direction. In a vertical direction in regions 613 through 617 and 631 through 635, however, kernel coefficients are applied with full granularity. With a single kernel coefficient applied in each of regions 602, 608, 610 and 612, granularity is reduced in both horizontal and vertical directions.

In this context, “full-granularity” kernel coefficients as referred to herein means kernel coefficients to be applied in a convolution operation that are not constrained from assuming any value within a set range or precision of values (e.g., particular floating point format having a fixed number of digits). For example, each full-granularity kernel coefficient of kernel coefficients to be applied to features (e.g., image signal intensity values) in a convolution operation may have a unique value among the applied kernel coefficients. Additionally in this context, “reduced-granularity” kernel coefficients as referred to herein means kernel coefficients that are constrained to be from a discrete set of coefficient values. For example, multiple reduced-granularity kernel coefficient of kernel coefficients to be applied to features in a convolution operation may assume the same coefficient value within such a discrete set of coefficient values.

According to an embodiment, image signal intensity values of an image frame (e.g., as per embodiment 600) may be organized in a two-dimensional array to represent a single image signal intensity value (e.g., integer or floating point) at pixel locations associated with spatial coordinates. For a multi-color channel image frame, image signal intensity values may be organized in a three-dimensional array to represent multiple image signal intensity at pixel locations associated with spatial coordinates.

In the particular example implementation of embodiment 600, kernel coefficients associated with adjacent/contiguous pixels may be combined and/or averaged to provide a single kernel coefficient to be applied to image signal intensity values of the adjacent/contiguous pixels. As pointed out above, for a multi-color image frame, kernel coefficients may be applied separately to image signal intensity values of separate color channels. In such an embodiment of a multi-color image frame, kernel coefficients may be combined/averaged to provide reduced-granularity kernel coefficients to be applied over individual color channels.

In a process to combine and/or average kernel coefficients for application to multi-color channel pixels arranged in a Bayer pattern (e.g., as shown in FIG. 1B), kernel coefficients applied to image signal intensity values of a particular color channel are to be applied to image signal intensity values of non-adjacent/non-contiguous pixel locations. As such, kernel coefficients adjacent/contiguous pixels in group of pixels 102 in FIG. 1C may not be combined and/or averaged. Instead, kernel coefficients for a single color channel (e.g., red) may be combined/averaged by skipping locations (e.g., between non-adjacent/non-contiguous pixel locations) such as by averaging/combining kernel coefficients to be applied to pixel locations 112. Such a combining/averaging of kernel coefficients may be applied over a greater concentration over green pixel locations such as kernel coefficients to be applied to pixel locations at pattern 122 in FIG. 1E. As this pattern is shifted by a single pixel location as shown by pattern 132 in FIG. 1F. However, averaging/combining kernel coefficients over pattern 132 does not work as there is a mixture of red and blue pixels.

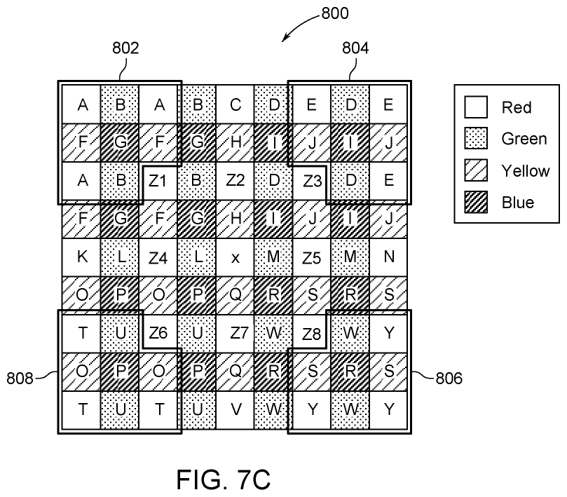

FIGS. 7A, 7B and 7C are schematic diagrams mapping kernel coefficients to image signal intensity values of four color channels. In the particular implementations of FIGS. 7A, 7B and 7C, a color space includes color channels for red, green, blue and a fourth-color. In one embodiment, a channel for such a fourth-color may comprise an infrared channel to provide an RGBIr color space. In another embodiment, a channel for such a fourth-color may comprise a second green channel to provide an RGGB color space. Other embodiments may be applied to non-RBG color spaces such as, for example, RCCY, RCCB and RCCC color spaces, just to provide a few examples. While the particular examples shown in FIGS. 7A, 7B and 7C are directed to color spaces implemented in a 2×2 pattern, other color spaces may be implemented in patterns of different dimensions such as an RGBIr color space implemented in a 4×4 pattern, for example. Predetermined coefficient values A, C, E, K, N, T, V and Y are to be applied to red image signal intensity values. Predetermined coefficient values B, D, L, M, U and W are to be applied to green image signal intensity values. Predetermined coefficient values G, I, P and R are to be applied to blue image signal intensity values. Predetermined coefficient values F, H, J, O, Q and S are to be applied to fourth-color image signal intensity values. In application of a kernel in FIGS. 7A, 7B and 7C to four color channels, a total of 25 kernel coefficients (to be reduced-granularity coefficient values A through Y) may be applied to image signal values associated with 81 pixel locations with a total of 25 multiplication operations. In a convolution operation, red image signal intensity values mapped to kernel coefficient A may be added/summed together, and the resulting sum may be multiplied by kernel coefficient A. Red image signal values mapped to kernel coefficients C, E, K, N, T, V and Y may be similarly processed. Convolution operations to apply kernel coefficients in channels for red, green, blue and fourth-color may then be formulated according to expressions (2) through (5) as follows:

$${g}_{R} ( x ) = A {\sum }_{{j}_{A}} {i}_{R} ( {j}_{A} ) + C {\sum }_{{j}_{C}} {i}_{R} ( {j}_{C} ) + E {\sum }_{{j}_{E}} {i}_{R} ( {j}_{E} ) + K {\sum }_{{j}_{K}} ( {j}_{k} ) + N {\sum }_{{j}_{N}} {i}_{R} ( {j}_{N} ) + T {\sum }_{{j}_{T}} {i}_{R} ( {j}_{T} ) + V {\sum }_{{j}_{V}} {i}_{R} ( {j}_{V} ) + Y {\sum }_{{j}_{Y}} {i}_{R} ( {j}_{Y} ) ; \qquad ( 2 )$$

$${g}_{G} ( x ) = B {\sum }_{{j}_{B}} {i}_{G} ( {j}_{B} ) + D {\sum }_{{j}_{D}} {i}_{G} ( {j}_{D} ) + L {\sum }_{{j}_{L}} {i}_{G} ( {j}_{L} ) + M {\sum }_{{j}_{M}} {i}_{G} ( {j}_{M} ) + U {\sum }_{{j}_{U}} {i}_{G} ( {j}_{U} ) + W {\sum }_{{j}_{W}} {i}_{G} ( {j}_{W} ) ; \qquad ( 3 )$$

$${g}_{B} ( x ) = G {\sum }_{{j}_{G}} {i}_{B} ( {j}_{G} ) + I {\sum }_{{j}_{I}} {i}_{B} ( {j}_{I} ) + P {\sum }_{{j}_{P}} {i}_{B} ( {j}_{P} ) + R {\sum }_{{j}_{R}} {i}_{B} ( {j}_{R} ) ; \qquad ( 4 )$$

$${g}_{4} ( x ) = F {\sum }_{{j}_{F}} {i}_{4} ( {j}_{F} ) + H {\sum }_{{j}_{H}} {i}_{4} ( {j}_{H} ) + J {\sum }_{{j}_{J}} {i}_{4} ( {j}_{J} ) + O {\sum }_{{j}_{O}} {i}_{4} ( {j}_{O} ) + Q {\sum }_{{j}_{Q}} {i}_{4} ( {j}_{Q} ) + S {\sum }_{{j}_{S}} {i}_{4} ( {j}_{S} ) , \qquad ( 5 )$$

where:
   g_{R}(x), g_{G}(x), g_{B}(x) and g₄(x) are convolution operations to produce a resulting output value for output pixel location x in FIGS. 7A and 7B for color channels of red, green, blue and fourth-color, respectively;
i_{R}(j_{θ}) is an image signal intensity value of a pixel for the red channel at pixel location j_{θ};
i_{G}(j_{θ}) is an image signal intensity value of a pixel for the green channel at output pixel location j_{θ};
i_{B}(j_{θ}) is an image signal intensity value of a pixel for the blue channel at output pixel location j_{θ}; and
i₄(j_{θ}) is an image signal intensity value of a pixel for the fourth-color channel at output pixel location je.

Expressions (2) through (5) show generation of separate output values for g_{R}(x), g_{G}(x), g_{B}(x) and g₄(x). In some embodiments, aspects of g_{R}(x), g_{G}(x), g_{B}(x) and g₄(x) may be selectively combined and/or added together to produce a single full-kernel convolution output value.

In the particular implementation of FIG. 7C, full-granularity coefficient values Z1, Z2, Z3, Z4, Z5, Z6, Z7 and Z8 are to be applied in a convolution operation to red image signal intensity values that nearest an output pixel location “x.” Image signal intensity values for other red pixels more distant from output pixel location “x” are convolved with kernel coefficient values A, C, E, K, N, T, V and Y (e.g., reduced-granularity kernel coefficient values). As pointed out above, application to red pixels more distant from output pixel location “x” of kernel coefficient values A, C, E, K, N, T, V and Y with diminished granularity/quantization may reduce use of computation resources while not significantly impacting convolution performance.

As illustrated above with embodiment 600, the same coefficient value selected from the set of reduced-granularity coefficient values may be applied to image signal intensity values of multiple pixel locations in the region based, at least in part, a location of the region relative to an output pixel location. For example, convolving image signal intensity values for multiple pixels in a region with the same coefficient value (e.g., lower granularity coefficient) may not significantly degrade convolution accuracy if the region is sufficiently offset from the output pixel location. Here, convolving the image signal intensity values of pixels in the region may comprise multiplying a sum of the image signal intensity values of the pixels in the region by the selected kernel coefficient.

As shown in FIG. 7B, at vertical edges of four-color channel embodiment 700, kernel coefficient values for a particular color channel may be mapped to a single value along a vertical direction in regions 701, 702, 703, 707, 708 and 709 at a vertical periphery extending from a center. In region 701, a single kernel coefficient B is uniformly applied to green pixels while a single kernel coefficient G is uniformly applied to blue pixels. In region 702, a single kernel coefficient C is uniformly applied to red pixels while a single kernel coefficient H is uniformly applied to fourth-color pixels. In region 703, a single kernel coefficient C is uniformly applied to red pixels while a single kernel coefficient H is uniformly applied to fourth-color pixels. In region 707, a single kernel coefficient P is uniformly applied to blue pixels while a single kernel coefficient U is uniformly applied to green pixels. In region 708, a single kernel coefficient V is uniformly applied to red pixels while a single kernel coefficient Q is uniformly applied to fourth-color pixels. In region 709, a single kernel coefficient R is uniformly applied to blue pixels while a single kernel coefficient W is uniformly applied to green pixels.

Also shown in FIG. 7B, at lateral edges of four-color channel embodiment 700, kernel coefficient values for a particular color channel may be mapped to a single value along a horizontal direction in regions 704, 705, 706, 710, 711 and 712 at a lateral periphery extending from a center. In region 704, a single kernel coefficient I is uniformly applied to blue pixels while a single kernel coefficient J is uniformly applied to fourth-color pixels. In region 705, a single kernel coefficient M is uniformly applied to green pixels while a single kernel coefficient N is uniformly applied to red pixels. In region 706, a single kernel coefficient R is uniformly applied to blue pixels while a single kernel coefficient S is uniformly applied to fourth-color pixels. In region 710, a single kernel coefficient F is uniformly applied to fourth-color pixels while a single kernel coefficient G is uniformly applied to blue pixels. In region 711, a single kernel coefficient K is uniformly applied to red pixels while a single kernel coefficient L is uniformly applied to green pixels. In region 712, a single kernel coefficient O is uniformly applied to fourth-color pixels while a single kernel coefficient P is uniformly applied to blue pixels.

Also shown in FIGS. 7B and 7C, at a region at both a lateral periphery and at a vertical periphery of four color channel embodiments 700 and 800, kernel coefficient values for a particular color channel may be mapped uniformly to a single value. In region 722 (FIG. 7B) and region 804 (FIG. 7C), for example, a single kernel coefficient E is uniformly applied to red pixels, a single kernel coefficient J is uniformly applied to fourth-color pixels and a single kernel coefficient I is applied to a blue pixel. Likewise in region 724 (FIG. 7B) and 806 (FIG. 7C), a single kernel coefficient Y is uniformly applied to red pixels, a single kernel coefficient S is uniformly applied to fourth-color pixels and a single kernel coefficient R is applied to a blue pixel. Similarly in region 726 (FIG. 7B) and region 808 (FIG. 7C), a single kernel coefficient T is uniformly applied to red pixels, a single kernel coefficient O is uniformly applied to fourth-color pixels and a single kernel coefficient P is applied to a blue pixel. Also in region 728 (FIG. 7B) and in region 802 (FIG. 7C), a single kernel coefficient A is uniformly applied to red pixels, a single kernel coefficient F is uniformly applied to fourth-color pixels and a single kernel coefficient G is applied to a blue pixel.

Another embodiment of a convolution operation to apply kernel coefficients to image signal intensity values for a single-channel and/or monochrome format, a convolution operation is shown in FIG. 8. In embodiment 850, a convolution operation may apply kernel coefficients to image signal intensity values of a 9×9 portion of pixels including a 3×3 center region 852. Center region 852 may be bordered by 3×3 peripheral regions 854, 856, 858, 860, 862 and 864. A convolution operation may apply a set of full-granularity kernel coefficients e, f, g, h, I, j, k, l and m to image signal intensity values of associated pixel locations of center region 852. For each peripheral region, the convolution operation may uniformly apply a single kernel coefficient from a set of reduced-granularity coefficient values (a, b, c, d, n, o, p or q) to image signal intensity values of all color channels and for all pixel locations in the peripheral region. Here, a total number of kernel coefficients is reduced to 17.

As pointed out above, in each of peripheral regions 854, 856, 858, 860, 862, 864, 866 and 868, a single kernel coefficient is to be applied to each image signal intensity value in the peripheral region. To further reduce usage of processing resources, image signal intensity values for all pixels in a peripheral region 854, 856, 858, 860, 862, 864, 866 and/or 868 may be mapped to a single image signal intensity value. In one implementation, such a single image signal intensity value for a particular peripheral region may be determined as an average (e.g., weighted) of image signal intensity values over all pixel locations in the particular peripheral region. In another particular implementation, such a single image signal intensity value for a particular peripheral region may be selected from among image signal intensity values of pixels in the particular peripheral region to be representative of all pixel locations in the particular peripheral region.

According to an embodiment, reduced-granularity kernel coefficients A through Y of FIGS. 7A, 7B and 7C may be determined based, at least in part, on full-granularity kernel coefficients computed for all 81 pixel locations centered at output pixel location x. Such full-granularity kernel coefficients may be determined using any of several techniques such as, for example, a kernel prediction network or other machine-learning process. In one implementation, for a particular color channel, a finite number of clusters of full-granularity may be identified where a cluster is to be associated with a particular representative kernel coefficient (e.g., mean of kernel coefficients in the cluster). In the presently illustrated example, full-granularity kernel coefficients for a red color channel for FIGS. 7A, 7B and 7C may be associated with clusters to be mapped to representative kernel coefficients A, C, E, K, N, T, V and Y. Similarly, full-granularity kernel coefficients for a green color channel for FIGS. 7A, 7B and 7C may be associated with clusters mapped to representative reduced-granularity kernel coefficients B, D, L, M, U and W. Likewise, full-granularity kernel coefficients for a blue color channel for FIGS. 7A, 7B and 7C may be associated with clusters mapped to representative reduced-granularity kernel coefficients G, I, P and R. Likewise, full-granularity kernel coefficients for a fourth-color color channel for FIGS. 7A, 7B and 7C may be associated with clusters mapped to representative reduced-granularity kernel coefficients F, H, J, O, Q and S.

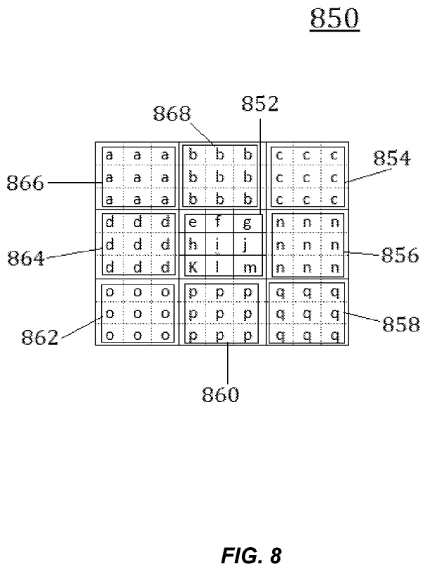

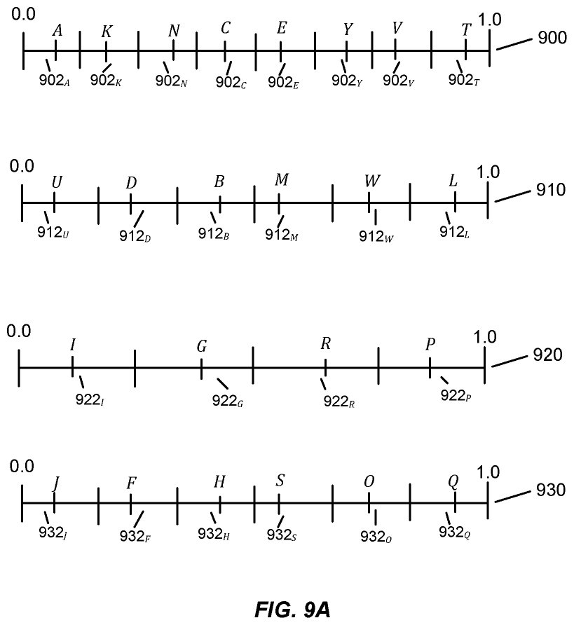

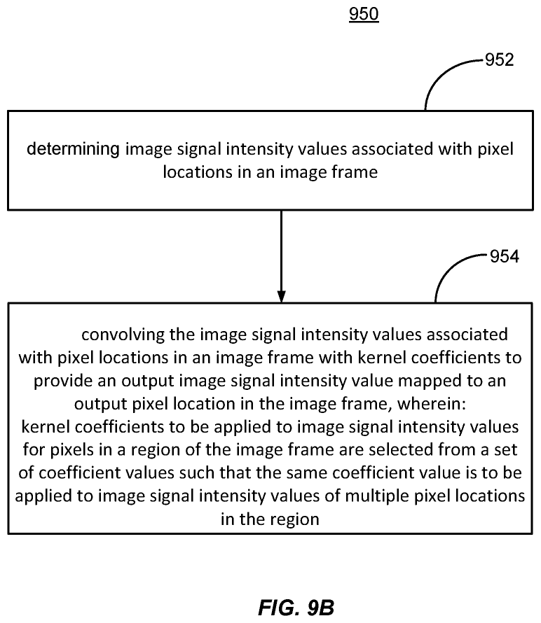

FIG. 9A is diagram showing mappings of ranges or bins to discrete kernel coefficient values of different sets kernel coefficients for multiple color channels, according to embodiments. Mappings 900, 910, 920 and 930 may map full-granularity kernel coefficients to discrete reduced-granularity kernel coefficient values for red, green, blue and fourth-color color channels, respectively, to be applied at convolution operations according to expressions (2) through (5). Mappings 900, 910, 920 and 930 may define bins or ranges within a normalized range of 0.0 to 1.0. For convolving red image signal intensity values according to expression (2), full-granularity kernel coefficients within bins or ranges 902A, 902K, 902N, 902c, 902E, 902y, 902v and 902r may map to discrete reduced-granularity kernel coefficient values for kernel coefficients A, K, N, C, E, Y, V and T, respectively. For convolving green image signal intensity values according to expression (3), full-granularity kernel coefficients within bins or ranges 912u, 912D, 912B, 912M, 912w and 912L, may map to discrete reduced granularity kernel coefficient values for kernel coefficients U, D, B, M, W and L, respectively. For convolving blue image signal intensity values according to expression (4), full-granularity kernel coefficients within bins or ranges 922_{I}, 922_{G}, 922_{R} and 922_{P}, may map to discrete reduced-granularity kernel coefficient values for kernel coefficients U, D, B, M, W and L, respectively. For convolving fourth-color image signal intensity values according to expression (5), full-granularity kernel coefficients within bins or ranges 932_{J}, 932_{F}, 932_{H}, 932_{S}, 932_{O} and 932_{Q}, may map to discrete kernel coefficient values for reduced granularity kernel coefficients J, F, H, S, O and Q, respectively.

While FIG. 9A provides an example of a mapping of full granularity kernel coefficients to reduced kernel coefficients, it should be understood that other, different mappings may be used without deviating from claimed subject matter. Additionally, in other embodiments, full granularity kernel coefficients may be mapped to reduced precision coefficient values such that the same kernel coefficient applied to multiple features in a feature map (e.g., image signal intensity values in an image frame) in a convolution operation may be either a reduced granularity coefficient value and/or a reduced precision coefficient value.

FIG. 9B is a flow diagram of a process 950 to apply kernel coefficients to elements of a feature map, according to an embodiment. Block 952 may comprise a determination of elements of a feature map. Such a feature map may comprise image signal intensity value at pixel locations, for example. In one implementation, block 952 may comprise determining image signal intensity values associated with pixel locations in an image frame. For example, block 952 may determine such image signal intensity values from sampled output signals of a monochrome imaging device or a Bayer pattern imaging device (e.g., as shown in FIG. 1A, 1B, 6A, 6B 7A, 7B, 7C or 8).

Block 954 may comprise application of one or more convolution operations to elements of a feature map determined at block 952 to provide an output image signal intensity value mapped to an output pixel location in an image frame. Kernel coefficients to be applied to image signal intensity values for pixels in a region of the image frame may be selected from a set of kernel coefficient values such that the same kernel coefficient value is to be applied to image signal intensity values of multiple pixel locations in the region. In the particular example of FIG. 7, for image signal intensity values in a red channel, such a set of coefficient values may comprise reduced-granularity kernel coefficient values for kernel coefficients A, C, E, K, N, T, V and Y. A convolution operation applied at block 954 may comprise application of kernel coefficients to image signal intensity values according to expressions (2) through (5), for example.

According to an embodiment, kernel coefficients may be selected to be applied to image signal intensity values of multiple pixel locations in a region based, at least in part, on a location of the region relative to an output pixel location of a convolution operation. As discussed above with reference to FIGS. 6B, 7B and 7C. For example, the same kernel coefficient may be applied to multiple pixels in a vertical direction at a vertical periphery with respect to the output pixel location. Likewise, the same kernel coefficient may be applied to multiple pixels in a horizontal direction at a lateral periphery with respect to the output pixel location.

According to an embodiment, block 952 may comprise one or more pre-processing operations as illustrated in FIGS. 9C and 9D. As shown, image signal intensity values of an input image 958 may be pre-processed at operation 960 based, at least in part, one or more configuration parameters. Here, pre-processing operation 960 may map full-granularity image signal intensity values of input image 958 to a set of reduced-granularity image signal intensity values to be processed at block 962 with reduced computational complexity. In a particular implementation, pre-processing operation 960 may be implemented as shown in FIG. 9D where image signal intensity values of a larger patch 972 derived from input image 958 may be reduced to a smaller patch 976 as an augmented portion of an image frame for processing at convolution operation 962.

In this context, “full-granularity” image signal intensity values as referred to herein means image signal intensity values to be processed in a convolution operation that are not constrained from assuming any value within a set range or precision of values (e.g., particular floating point format having a fixed number of digits). For example, each full-granularity image signal intensity value of image signal intensity values to be applied to be processed in a convolution operation may have a unique value among the processed image signal intensity values. Additionally in this context, “reduced-granularity” image signal intensity values as referred to herein means image signal intensity values that are constrained to be from a discrete set of image signal intensity values. For example, multiple reduced-granularity image signal intensity values to be processed in a convolution operation may assume the same image signal intensity value within such a discrete set of image signal intensity values.

In the particular example of FIG. 9D, operation 974 may receive a portion 978 of image signal intensity values of larger patch 972 to be processed while a remaining portion of may be mapped directly to smaller patch 976 without alteration. In one example implementation, the remaining unaltered portion may include image signal intensity values that are neighboring an output pixel location of convolution operation 962 while portion 978 may include image signal values in one or more regions in larger patch 972 that are peripheral to the unaltered portion. In one embodiment, operation 974 may be selectively controlled by a configuration selection value that is to be based on a particular selectable mode to process image signal intensity values of portion 978 to produce image signal intensity values 980 to be mapped to one or more portions of smaller patch 976. In one example selectable mode, operation 974 may select image signal intensity values of a subset of pixel locations in portion 978 to be included in image signal intensity values 980 to be representative of all pixel locations in portion 978. In another example selectable mode, operation 974 may map image signal intensity values of multiple pixel locations in portion 978 to the same, reduced-granularity image signal intensity value by combining and/or averaging.

According to an embodiment, block 952 may map image signal intensity values of a plurality of contiguous pixel locations in a portion of an image frame to a single image signal intensity value to be representative of the contiguous pixel locations in an augmented portion of the image frame. In an implementation, such a single image signal intensity value to be representative of the contiguous pixel locations may be multiplied by a coefficient value selected from a set of kernel coefficient values to provide an output image signal intensity value based on the computed product. Such a selected coefficient value may comprise a reduced-granularity coefficient value as described above.

According to an embodiment, a state of “configuration” signal shown in FIGS. 9C and 9D may be set and/or determined at processing runtime (e.g., responsive to runtime conditions such as an availability of processing resources). A state of “configuration” signal shown in FIGS. 9C and 9D may select a mode from multiple available modes to reduce a total number of kernel coefficients to be applied in convolution 926 (e.g., using reduced granularity and/or reduced precision kernel coefficients as illustrated in FIGS. 6A, 6B, 7A, 7B, 7C and 8) and/or reduce a total number of features (e.g., image signal intensity values) to be convolved (e.g., by mapping multiple image signal intensity values in a region to a single image signal intensity value to represent the entire region).

As pointed out above in embodiment 800 in FIG. 8, in one implementation, image signal intensity values of contiguous pixel locations a peripheral region 854, 856, 858, 860, 862 and 864 may be mapped to a single image intensity value that may be computed as an average of image signal intensity values. In another implementation, image signal intensity values of contiguous pixel locations a peripheral region 854, 856, 858, 860, 862 and 864 may be mapped to a single image intensity value that is of a selected pixel location in the peripheral region. In one example, such a pixel location may be randomly selected from among contiguous pixel locations in the peripheral region. In another example, such a pixel location may be selected as being from a particular location within the peripheral region such as, for example, a center of the peripheral region, a location nearest an output pixel location of a subsequent convolution operation or a location furthest from an output pixel location of a subsequent convolution operation, just to provide few examples.

One particular technique for reducing memory usage and/or multiplication operations in application of a kernel operation in a color channel over a region of an image may comprise a skipping of image signal intensity values in the color channel for at least some pixel locations in the region (e.g., and normalizing kernel coefficient products accordingly). In one example, such a skipping of image signal intensity values may comprise a convolution operation in which only image signal intensity values of the same color channel for every other pixel are to be multiplied by a corresponding kernel coefficient. In another example, such a skipping of image signal intensity values may comprise a convolution operation in which image signal intensity values of neighboring pixels of the same color channel are averaged or combined. Here, a single kernel coefficient is to be applied for both pixels by multiplying the averaged/combined image signal intensity value by the single kernel coefficient in a single multiplication operation.

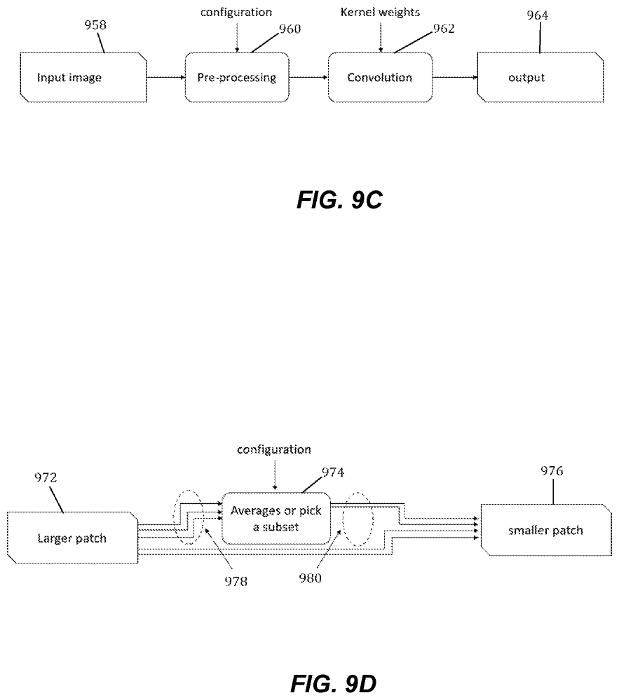

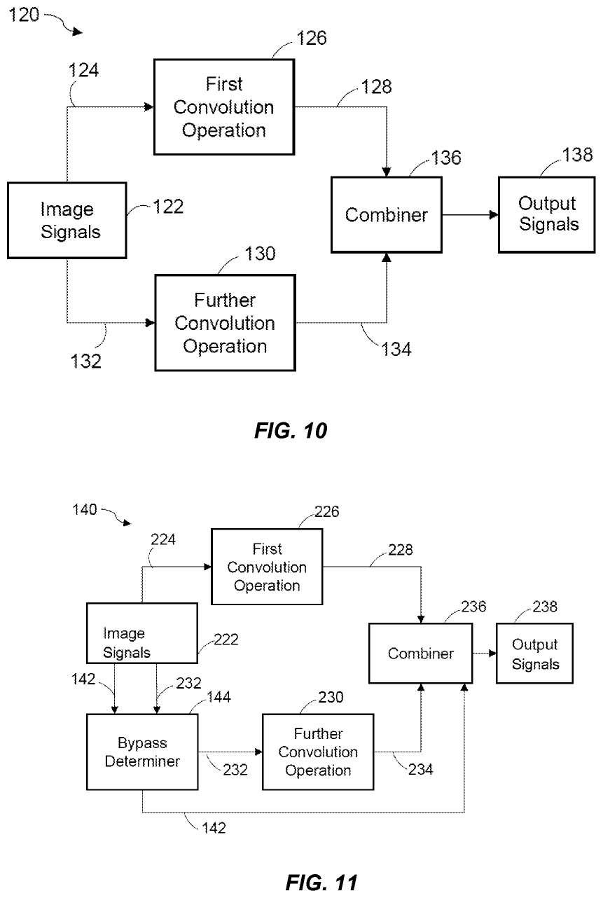

According to an embodiment, an image processing operation may be capable of selectively applying a convolution operation (e.g., any convolution operation applied at blocks 126 (FIG. 10), 130 (FIG. 10), 226 (FIG. 11) and/or 230 (FIG. 11)) in any one of multiple modes based, at least in part, on processing conditions, for example. In a first such mode, a convolution operation may be performed using skipping (e.g., applying a kernel coefficient to only every other image signal intensity value of the same color channel) as described above.

In a second such mode of multiple modes, a convolution operation may be applied with reduced granularity kernel coefficients, such as by mapping full-granularity kernel coefficients to a set of discrete coefficient values (e.g., according to expressions (2) through (5)) and/or with a reduced granularity image signal intensity values (e.g., in regions set off from an output pixel location of the convolution operation). In a third such mode of multiple modes, a convolution operation may be applied with a full granularity kernel with full granularity image signal intensity values. As indicated above, it may be observed that the first and second identified modes may enable a reduction in memory usage and multiplication operations over the third mode operation. In one particular implementation, the third mode of operation may be applied over a reduced region. In particular implementations, a particular convolution mode of the first, second and third modes may be selected based on particular conditions and/or desired robustness to noise.

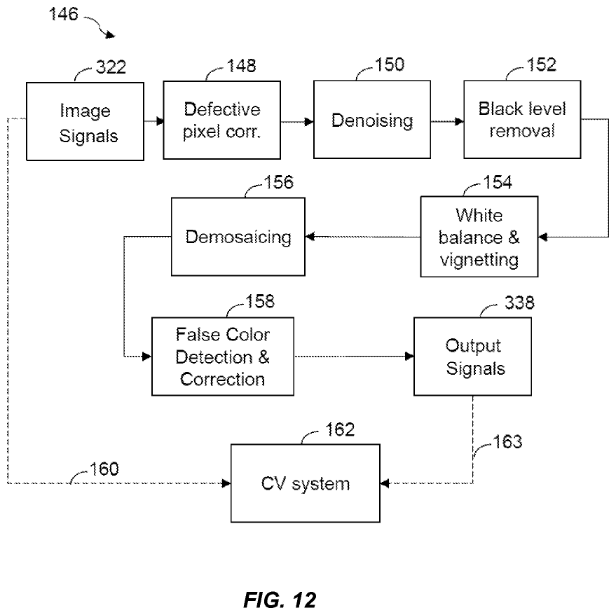

FIG. 10 is a schematic diagram showing a technique 120 of processing image signals 122 which includes a plurality of image signal intensity values 124. In technique 120 of FIG. 15, processing the image signals 122 includes applying a first convolution operation 126 to the plurality of image signal intensity values 124, thereby generating signals 128. In this example, the first convolution operation 126 may be any one of the convolution operations 204, 304, 404 of FIG. 3, 4 or 5, convolution operation of block 954 and/or convolution operations of expressions (2) through (5). Signals 128 generated by first convolution operation 126 may therefore include one of the output signal values 206, 306, 406 of FIG. 3, 4 or 5, and/or functions g_{R}(x), g_{G}(x), g_{B}(x), and/or g₄(x). In technique 120, the first convolution operation 126 is applied as part of a demosaicing algorithm applied to the image signals 122. However, it is to be appreciated that technique 120 of FIG. 10 may be applied in examples where the first convolution operation 126 is applied for a different purpose. Demosaicing for example, may allow for an image signal intensity value for each color channel to be obtained for each pixel location as described in more detail below with reference to FIG. 12. In this example, a Bayer filter array may be used to capture the image, and so signals 128 may include an array of output signal values which, for a pixel location of the image, represent an image signal intensity value for each color channel.

Technique 120 may also include applying a further convolution operation 130 to at least some image signal intensity values 132 of the plurality of image signal intensity values 124 using a further kernel, thereby generating output signals 134. In this example, the further kernel used in convolution operation 130 represents a bandpass filter for edge detection. Such a bandpass filter may be used to suppress low- and high-frequency components of an image represented by the at least some 132 of the plurality of image signal intensity values 124. For example, lower-frequency components may not provide sufficient information regarding a contrast of an image. Conversely, high-frequency components may be sensitive to high-contrast image features, and hence may be subject to noise. Coefficients of the further kernel may be used to perform the further convolution 130 may be predetermined. In this way the bandpass filter may be tuned such that coefficients of the further kernel determine frequencies of the low- and high-frequency components of the image that are suppressed by convolution operation 130. Alternatively, in cases where convolution operation is applied to implement at least part of a neural network architecture, coefficients of the further kernel may be learned during a training phase of the neural network. Alternatively, coefficients of the further kernel may be derived as part of an automated tuning process of an image signal processing system, such as the image processing system described with reference to FIG. 10. It is to be understood that convolution operation 130 may utilize any of the above-described methods 110, 114, 118 of FIG. 3, 4 or 5, and/or expressions (2) through (5) in order to reduce a number of multiplication operations required by an image processing system to perform convolution operation 130. In this example, signals 134 may include a grayscale image showing the edges detected in the image by applying convolution operation 130. In this case, a grayscale image may include an array of image signal intensity values of the same size as the array of output signal values of signals 128.

In technique 120, a combiner 136 combines signals 128 of the first convolution operation 126 with signals 134 of convolution operation 130, thereby generating the output signals 138. In this way, the output signals 138 may include a combination of information regarding edges detected in the image by applying convolution operation 130 and information obtained from the first convolution operation 126 applied to the plurality of image signal intensity values 124. For example, the combiner 136, for a given pixel location, may combine an image signal intensity value of the grayscale image from the signals 134 of convolution operation 130 with each of the image signal intensity values for each color channel from signals 128 of the first convolution operation 126. This may include adding the image signal intensity value of the grayscale image to each of the image signal intensity values for each color channel. By combining both signals 128 of the first convolution operation 126 and the signal 134 of convolution operation 130, the output signals 138 in this example includes information regarding detected edges in the image represented by the image signals 122, and an amount of noise in the image is also reduced. In this example where the first convolution operation 126 is used as part of a demosaicing algorithm, the output signals 138 includes an array of output signal values which for each pixel location of the image, represents an image signal intensity value for each color channel, with additional information regarding detected edges in the image represented by the image signals 122. In this way, an output image represented by the output signals 138 may provide a sharper image around the detected edges.

As pointed out above, for an imaging device that captures an image, a pixel location may be associated with a red color channel, and demosaicing may allow for image signal intensity values for the green and blue channels to be obtained for that pixel location. Demosaicing for example may involve interpolating between and/or among neighboring pixels of the same color channel to obtain an image signal intensity value at a location between these neighboring pixels, such as at a location corresponding to a pixel of a different color channel. This may be performed for each of a plurality of color channels in order to obtain, at each pixel location, an image signal intensity value for each of the color channels. In some cases, grayscale demosaicing may be performed, in which a grayscale intensity is obtained at each pixel location indicating an image signal intensity value for a single color channel (e.g. from white (lightest) to black (darkest)). An example image processing pipeline including a demosaicing algorithm is described below with reference to FIG. 12.

In an example, each pixel location is associated with one of a first color channel and a further color channel. For example, where a color filter pattern is a Bayer filter pattern, the first color channel may be a red color channel and the further color channel may be a green color channel. The processing of FIG. 10 may be applied to such an example. In this case, convolution operation 130 of FIG. 10 is applied to some 132 of the plurality of image signal intensity values 124. Convolution operation 130 may be such that the further output 134 comprises equal contributions from pixel locations associated with the first color channel and pixel locations associated with the further color channel, independent of a pixel location associated with a respective image signal intensity value to which convolution operation 130 is applied. A respective image signal intensity value to which a convolution operation is to be applied may be understood as the image signal intensity value associated with a central pixel location that corresponds with a central coefficient (e.g., coefficient to be applied to an image signal intensity value of an output pixel, sometimes referred to as an ‘anchor point’) of the kernel. In a convolution operation, such a central coefficient may be applied to an image signal intensity value corresponding to an output pixel location of the convolution operation, for example.

According to an embodiment, coefficients of a kernel applied in convolution operation 130 may be determined such that a bandpass filter detects edges in the image represented by the image signals 122, but suppresses the high-frequency Bayer pattern component. For example, edges detected in an image by applying convolution operation 130 may represent edges of a scene represented by the image, and not high-frequency edges resulting from a color filter pattern of the color filter array.

In particular examples where a Bayer filter array is used to capture an image, a color of signals 134 may be grayscale because signals 134 may include equal contributions from pixel locations associated with each of the red, green and blue color channels. Combining a grayscale image with the image signal intensity values for each of the red, green and blue color channels (e.g., derived from demosaicing the image signals 122) may effectively desaturate an image around detected edges, which may reduce a chance of false colors being present around edges in the output signals 138. False colors, also sometimes referred to as colored artifacts, may occur when performing convolution operations that combine contributions from image signal intensity values associated with different color channels. An output of such a convolution operation may be an image signal intensity value that differs significantly from an original image signal intensity value at the same pixel location representing the actual color of a scene represented by the image. This difference may be visually noticeable in an output image as a color not present in an original input image. False colors may hence appear as erroneous to a viewer, so it is desirable for their presence to be reduced, e.g. by performing convolution operation 130.

In a case where a color filter pattern is a Bayer filter pattern, a kernel used to apply convolution operation 130 may be referred to as a “Bayer invariant kernel”. Signals 134 in this example may include equal contributions from pixel locations associated with the red, blue and green color channels, independent of a pixel location to which convolution operation 130 is applied. An example of a Bayer invariant 3×3 kernel is:

$$( \begin{matrix}1 & 2 & 1 \\ 2 & 4 & 2 \\ 1 & 2 & 1\end{matrix} ) .$$

However, this is not intended to be limiting, as many other Bayer invariant kernels of a different size, shape and/or dimensionality are possible without deviating from claimed subject matter.

FIG. 11 is a flow diagram showing a technique 140 of processing image signals 222 which may include a plurality of image signal intensity values 224. Features of FIG. 11 are similar to corresponding features of FIG. 10 are labelled with the same reference numeral but incremented by 100; corresponding descriptions are taken to apply.

In this example, the image signal intensity values 232 of the plurality of image signal intensity values 224 that are processed using convolution operation 230 are a first set of the plurality of image signal intensity values 232 and the image signals also includes a second, different set of the plurality of image signal intensity values 142. Technique 140 of FIG. 11 includes a bypass determiner 144, which may determine whether to bypass applying convolution operation 230 to the image signal intensity values 232. In this case, the bypass determiner 144 may determine to bypass applying convolution operation 230 to at least the second set of the plurality of image signal intensity values 142. In this way, the bypass determiner 144 determines to apply convolution operation 230 to chosen image signal intensity values of the plurality of image signal intensity values (e.g., to the first set of the plurality of image signal intensity values 232), which may correspond to applying the bandpass filter for edge detection to determined regions of the image represented by image signals 222. In some examples, performing the above-mentioned determining for the second set of the plurality of image signal intensity values 142 may come at a cost of not detecting edges for this part of the image represented by the second set of the plurality of image signal intensity values 142.

A bypass determination may be based, at least in part, on properties of the image signals 222. In one example, bypass determiner 144 may perform the above-mentioned determination based on an amount of information related to at least one color channel in the second set of the plurality of image signal intensity values 142. For example, bypass determiner 144 may determine that there is not sufficient information related to the at least one color channel in the second set of the plurality of image signal intensity values 142 to apply convolution operation 230 without generating an undesirable level of false edges or other image artifacts.

FIG. 12 is a schematic diagram showing an image processing pipeline 146 for processing image signals 322 to generate output signals 338. In this example, applying any of the convolution operations 204, 304, 404 described above with reference to FIGS. 4, 5 and 10, or in expressions (2) through (5) may form at least part of a demosaicing algorithm within the image processing pipeline 146.

In the image processing pipeline 146 of FIG. 12, image signals 322 may undergo defective pixel correction 148. In this way, image signals 322 may be compensated for defective sensor pixels, such as those that are broken, damaged or otherwise not fully functional. For example, an image signal intensity value for a defective pixel may be obtained based on image signal intensity values of at least one nearby non-defective sensor pixel. For example, such an image signal intensity value may be obtained by interpolating image signal intensity values of at least two neighboring non-defective sensor pixels.

In the image processing pipeline 146 of FIG. 12, denoising 150 is applied to the image signals 322 to remove noise present in the image signals 322. Noise may arise in the image signals 322 from several sources. Shot noise, arising due to the quantized nature of light, may occur in the photon count of the image sensor. Dark current noise arises from small currents in the image sensor when no radiation is being received and may be dependent on environmental factors such as temperature. Read noise arises from the electronics in the image sensor and is related to the level of analogue gain used by the image sensor. At least one denoising algorithm may be applied to remove noise arising from at least one of a plurality of noise sources.

The image signal intensity values represented by the image signals 322 may include pedestal values, which may comprise constant values which are added to image signal intensity values to avoid negative image signal intensity values during an image capture process. For example, a sensor pixel may still register a non-zero sensor pixel value even if exposed to no light, e.g. due to noise. To avoid reducing image signal intensity values to less than zero, pedestal values may be added. Hence, before further processing is performed, image signals 322 in the image processing pipeline 146 of FIG. 12 may undergo black level removal 152 to remove the pedestal values.

In the image processing pipeline 146 of FIG. 12, white balance and vignetting 154 may be performed. White balance may involve adjusting at least some of the image signal intensity values so that the color of white, or other light or neutral-colored, objects in a scene is accurately represented. Vignetting, sometimes referred to as lens shading, is a phenomenon of the brightness or intensity of an image gradually decreasing radially away from the center of the image. Vignetting may be caused by various features of an image capture device, and may be corrected for using various algorithms.

In the image processing pipeline 146 of FIG. 12, the image signals 322 may undergo false color detection and correction 158. In this example, performing false color detection includes detecting a region of the image comprising an image signal intensity value with a measured error exceeding a threshold. This measured error may be referred to as a false color, or colored artifact as described above. Such a measured error may be associated with demosaicing algorithm 156. For example, the measured error may arise due to demosaicing algorithm 156 because an image signal intensity value for a color channel at a given pixel location obtained by interpolating between adjacent pixels of the same color channel may not always accurately depict the color of the scene represented by the image. For example, in a case where a Bayer filter array is used to capture the image represented by the image signals 322, a false color may arise due to the image represented by the image signals 322 including high frequency periodic information, such that the output of the demosaicing algorithm 156 includes interpolated image signal intensity values that do not always accurately capture the color of the scene. This can be visualized by considering an example of an image which includes black and white stripes at a high frequency, such that a 5×5 array of image signal intensity values for this image for example may be represented as:

$$[ \begin{matrix}0 & 1 & 0 & 1 & 0 \\ 0 & 1 & 0 & 1 & 0 \\ 0 & 1 & 0 & 1 & 0 \\ 0 & 1 & 0 & 1 & 0 \\ 0 & 1 & 0 & 1 & 0\end{matrix} ] ,$$

where 0 represents black, and 1 represents white. In this example, a corresponding 5×5 Bayer filter pattern used by an image sensor to capture the image may be shown as:

$$[ \begin{matrix}R & G & R & G & R \\ G & B & G & B & G \\ R & G & R & G & R \\ G & B & G & B & G \\ R & G & R & G & R\end{matrix} ] ,$$

where R represents the red filter elements, B represents the blue filter elements and G represents the green filter elements. In this case, capturing the above 5×5 image of black and white stripes using this Bayer filter pattern may generate the following 5×5 array of image signal intensity values:

$$[ \begin{matrix}0 & {G}_{12} & 0 & {G}_{14} & 0 \\ 0 & {B}_{22} & 0 & {B}_{24} & 0 \\ 0 & {G}_{32} & 0 & {G}_{34} & 0 \\ 0 & {B}_{42} & 0 & {B}_{44} & 0 \\ 0 & {G}_{52} & 0 & {G}_{54} & 0\end{matrix} ] ,$$

where Gᵢⱼ and Bᵢⱼ represent image signal intensity values associated with the green and blue color channels respectively, at a pixel location with row number i and column number j. As can be seen in this example, there is no information related to the red color channel, and information related to the green color channel has been significantly reduced compared to the originally captured image. On this basis, performing the demosaicing algorithm 156 may generate a resulting image that appears blue, which would not accurately correspond to the color of the scene represented by the original image (i.e., black and white stripes).

In this example, a measured error may be obtained by using information associated with the green color channel from the image signals 322 to identify high frequency regions of the image represented by the image signals 322 for which false colors may be expected to occur due to the demosaicing algorithm 156. The threshold which the measured error is compared to may be predetermined to correspond to a minimum magnitude of the measured error for which false color correction is to be applied. In this example, false color correction includes processing a portion of the image signals representing the region of the image to desaturate the region of the image. Saturation refers to the colorfulness of an area judged in proportion to its brightness, in which colorfulness refers to perceived chromatic nature of a color. Desaturating the region of the image may include adding shades of gray to the region of the image, thereby reducing the colorfulness of the region of the image and suppressing any false colors resulting from applying the demosaicing algorithm 156. In this way, the false color detection and correction 158 reduces a presence of false colors in the image represented by the image signals 322.

It is to be appreciated that the image processing pipeline of FIG. 12 is merely an example, and other image processing pipelines may omit various steps (such as at least one of defective pixel correction 148, denoising 150, black level removal 152 and while balance and vignetting 154), may have a different order of steps and/or may include additional processing steps. For example, defective pixel correction 148 and/or denoising 150 may be applied to the image signals 322 before the image signals 322 is processed by an image processing pipeline. As another example, black level removal 152 may be omitted if no pedestal values are added.

In the image processing pipeline 146 of FIG. 12, the image signals 322 includes green color channel signals 160. For example, where a Bayer filter array is used to capture the image represented by the image signals 322, the image signals includes green color channel signals 160 which includes green image signal intensity values (i.e., green pixel intensity values) for each pixel location in the Bayer filter array associated with the green color channel. In this case, the image signals 322 may similarly include red color channel signals and blue color channel signals. In the image processing pipeline of FIG. 12, the green color channel signals 160 is input to both the demosaicing algorithm 156 (as part of the image signals 322), which processes the image signals 322 as described above, and to a computer vision (CV) system 162 to implement CV functionality. CV functionality may include the processing of image signals to extract relatively high-level information describing content of the image. The CV system 162 may comprise artificial neural networks (ANNs) such as convolutional neural networks (CNN) to extract this information. CV functionality may include performing object detection and/or recognition. CV functionality may include other tasks such as motion estimation, scene reconstruction or image restoration. In some examples, CV functionality includes performing simultaneous localization and mapping (SLAM). SLAM comprises generating and/or updating a map of an environment whilst simultaneously determining and/or tracking a location of a sensor within the environment. SLAM processing may involve identifying and locating objects in the environment, and using those identified objects as semantic “landmarks” to facilitate the accurate and/or efficient mapping of the environment. CV functionality may be used for various purposes, for example in the robotics or automotive industries.

Inputting the green color channel signals 160 to the CV system 162 may be preferred compared to inputting interpolated values output from the demosaicing algorithm 156 to the CV system 162 because errors from the demosaicing algorithm 156, e.g. false colors or colored artifacts, may be carried forward and therefore impact on an accuracy of the CV functionality implemented by the CV system 162. In this example, however, the green color channel signals 160, which may be obtained from raw image signals captured by an image sensor and not derived using the demosaicing algorithm 156 for example, has a lower contribution from such false colors, thereby improving the accuracy of the CV functionality. In some examples, though, interpolated values 163 from the output signals 338 may also or instead be input to the CV system 162 in addition to or instead of the green color channel signals. The interpolated values 163 for example include red and blue image signal intensity values (i.e. red and blue pixel intensity values) for each pixel location in the Bayer filter array associated with the green color channel. These interpolated values 163 are obtained by performing the demosaicing algorithm 156 as described above. In this way, for each pixel location in the Bayer filter array associated with the green color channel, the CV system 162 may obtain image signal intensity values associated with each of the green, red and blue color channels. It is to be appreciated that whether to input green color channel signals 160 and/or the interpolated values 163 to the CV system, may be predetermined based on the CV functionality implemented by the CV system 162. In other examples, red color channel signals or blue color channel signals from the image signals 322 may instead be input to the CV system 162, and the interpolated values 163 in this case include image signal intensity values for the other of red or blue, and green image signal intensity values (i.e., green pixel intensity values) from the output signals 338.

According to an embodiment techniques 100, 110, 114, 118, 120 and 140, pipeline 146 and/or process 950 may be formed by and/or expressed in transistors and/or lower metal interconnects (not shown) in processes (e.g., front end-of-line and/or back-end-of-line processes) such as processes to form complementary metal oxide semiconductor (CMOS) circuitry, just as an example. It should be understood, however that this is merely an example of how circuitry may be formed in a device in a front end-of-line process, and claimed subject matter is not limited in this respect.

It should be noted that the various circuits disclosed herein may be described using computer aided design tools and expressed (or represented), as data and/or instructions embodied in various computer-readable media, in terms of their behavioral, register transfer, logic component, transistor, layout geometries, and/or other characteristics. Formats of files and other objects in which such circuit expressions may be implemented include, but are not limited to, formats supporting behavioral languages such as C, Verilog, and VHDL, formats supporting register level description languages like RTL, and formats supporting geometry description languages such as GDSII, GDSIII, GDSIV, CIF, MEBES and any other suitable formats and languages. Storage media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, etc.).

If received within a computer system via one or more machine-readable media, such data and/or instruction-based expressions of the above described circuits may be processed by a processing entity (e.g., one or more processors) within the computer system in conjunction with execution of one or more other computer programs including, without limitation, net-list generation programs, place and route programs and the like, to generate a representation or image of a physical manifestation of such circuits. Such representation or image may thereafter be used in device fabrication, for example, by enabling generation of one or more masks that are used to form various components of the circuits in a device fabrication process (e.g., wafer fabrication process).

In the context of the present patent application, the term “between” and/or similar terms are understood to include “among” if appropriate for the particular usage and vice-versa. Likewise, in the context of the present patent application, the terms “compatible with,” “comply with” and/or similar terms are understood to respectively include substantial compatibility and/or substantial compliance.

For one or more embodiments, systems described herein may be implemented in a device, such as a computing device and/or networking device, that may comprise, for example, any of a wide range of digital electronic devices, including, but not limited to, desktop and/or notebook computers, high-definition televisions, digital versatile disc (DVD) and/or other optical disc players and/or recorders, game consoles, satellite television receivers, cellular telephones, tablet devices, wearable devices, personal digital assistants, mobile audio and/or video playback and/or recording devices, Internet of Things (IoT) type devices, in-vehicle electronics or advanced driver-assistance systems (ADAS), or any combination of the foregoing. Further, unless specifically stated otherwise, a process as described, such as with reference to flow diagrams and/or otherwise, may also be executed and/or affected, in whole or in part, by a computing device and/or a network device. A device, such as a computing device and/or network device, may vary in terms of capabilities and/or features. Claimed subject matter is intended to cover a wide range of potential variations. For example, a device may include a numeric keypad and/or other display of limited functionality, such as a monochrome liquid crystal display (LCD) for displaying text, for example. In contrast, however, as another example, a web-enabled device may include a physical and/or a virtual keyboard, mass storage, one or more accelerometers, one or more gyroscopes, global positioning system (GPS) and/or other location-identifying type capability, and/or a display with a higher degree of functionality, such as a touch-sensitive color 2D or 3D display, for example.

In the context of the present patent application, the term “connection,” the term “component” and/or similar terms are intended to be physical but are not necessarily always tangible. Whether or not these terms refer to tangible subject matter, thus, may vary in a particular context of usage. As an example, a tangible connection and/or tangible connection path may be made, such as by a tangible, electrical connection, such as an electrically conductive path comprising metal or other conductor, that is able to conduct electrical current between two tangible components. Likewise, a tangible connection path may be at least partially affected and/or controlled, such that, as is typical, a tangible connection path may be open or closed, at times resulting from influence of one or more externally derived signals, such as external currents and/or voltages, such as for an electrical switch. Non-limiting illustrations of an electrical switch include a transistor, a diode, etc. However, a “connection” and/or “component,” in a particular context of usage, likewise, although physical, can also be non-tangible, such as a connection between a client and a server over a network, particularly a wireless network, which generally refers to the ability for the client and server to transmit, receive, and/or exchange communications, as discussed in more detail later.

In a particular context of usage, such as a particular context in which tangible components are being discussed, therefore, the terms “coupled” and “connected” are used in a manner so that the terms are not synonymous. Similar terms may also be used in a manner in which a similar intention is exhibited. Thus, “connected” is used to indicate that two or more tangible components and/or the like, for example, are tangibly in direct physical contact. Thus, using the previous example, two tangible components that are electrically connected are physically connected via a tangible electrical connection, as previously discussed. However, “coupled,” is used to mean that potentially two or more tangible components are tangibly in direct physical contact. Nonetheless, “coupled” is also used to mean that two or more tangible components and/or the like are not necessarily tangibly in direct physical contact, but are able to co-operate, liaise, and/or interact, such as, for example, by being “optically coupled.” Likewise, the term “coupled” is also understood to mean indirectly connected. It is further noted, in the context of the present patent application, since memory, such as a memory component and/or memory states, is intended to be non-transitory, the term physical, at least if used in relation to memory necessarily implies that such memory components and/or memory states, continuing with the example, are tangible.

Unless otherwise indicated, in the context of the present patent application, the term “or” if used to associate a list, such as A, B, or C, is intended to mean A, B, and C, here used in the inclusive sense, as well as A, B, or C, here used in the exclusive sense. With this understanding, “and” is used in the inclusive sense and intended to mean A, B, and C; whereas “and/or” can be used in an abundance of caution to make clear that all of the foregoing meanings are intended, although such usage is not required. In addition, the term “one or more” and/or similar terms is used to describe any feature, structure, characteristic, and/or the like in the singular, “and/or” is also used to describe a plurality and/or some other combination of features, structures, characteristics, and/or the like. Likewise, the term “based on” and/or similar terms are understood as not necessarily intending to convey an exhaustive list of factors, but to allow for existence of additional factors not necessarily expressly described.

Also, for one or more embodiments, an electronic document and/or electronic file may comprise a number of components. As previously indicated, in the context of the present patent application, a component is physical, but is not necessarily tangible. As an example, components with reference to an electronic document and/or electronic file, in one or more embodiments, may comprise text, for example, in the form of physical signals and/or physical states (e.g., capable of being physically displayed). Typically, memory states, for example, comprise tangible components, whereas physical signals are not necessarily tangible, although signals may become (e.g., be made) tangible, such as if appearing on a tangible display, for example, as is not uncommon. Also, for one or more embodiments, components with reference to an electronic document and/or electronic file may comprise a graphical object, such as, for example, an image, such as a digital image, and/or sub-objects, including attributes thereof, which, again, comprise physical signals and/or physical states (e.g., capable of being tangibly displayed). In an embodiment, digital content may comprise, for example, text, images, audio, video, and/or other types of electronic documents and/or electronic files, including portions thereof, for example.

Also, in the context of the present patent application, the term “parameters” (e.g., one or more parameters), “coefficients” (e.g., one or more coefficients), “values” (e.g., one or more values), “symbols” (e.g., one or more symbols) “bits” (e.g., one or more bits), “elements” (e.g., one or more elements), “characters” (e.g., one or more characters), “numbers” (e.g., one or more numbers), “numerals” (e.g., one or more numerals) or “measurements” (e.g., one or more measurements) refer to material descriptive of a collection of signals, such as in one or more electronic documents and/or electronic files, and exist in the form of physical signals and/or physical states, such as memory states. For example, one or more parameters, values, symbols, bits, elements, characters, numbers, numerals or measurements, such as referring to one or more aspects of an electronic document and/or an electronic file comprising an image, may include, as examples, time of day at which an image was captured, latitude and longitude of an image capture device, such as a camera, for example, etc. In another example, one or more parameters, values, symbols, bits, elements, characters, numbers, numerals or measurements, relevant to digital content, such as digital content comprising a technical article, as an example, may include one or more authors, for example. Claimed subject matter is intended to embrace meaningful, descriptive parameters, values, symbols, bits, elements, characters, numbers, numerals or measurements in any format, so long as the one or more parameters, values, symbols, bits, elements, characters, numbers, numerals or measurements comprise physical signals and/or states, which may include, as parameter, value, symbol bits, elements, characters, numbers, numerals or measurements examples, collection name (e.g., electronic file and/or electronic document identifier name), technique of creation, purpose of creation, time and date of creation, logical path if stored, coding formats (e.g., type of computer instructions, such as a markup language) and/or standards and/or specifications used so as to be protocol compliant (e.g., meaning substantially compliant and/or substantially compatible) for one or more uses, and so forth.

Signal packet communications and/or signal frame communications, also referred to as signal packet transmissions and/or signal frame transmissions (or merely “signal packets” or “signal frames”), may be communicated between nodes of a network, where a node may comprise one or more network devices and/or one or more computing devices, for example. As an illustrative example, but without limitation, a node may comprise one or more sites employing a local network address, such as in a local network address space. Likewise, a device, such as a network device and/or a computing device, may be associated with that node. It is also noted that in the context of this patent application, the term “transmission” is intended as another term for a type of signal communication that may occur in any one of a variety of situations. Thus, it is not intended to imply a particular directionality of communication and/or a particular initiating end of a communication path for the “transmission” communication. For example, the mere use of the term in and of itself is not intended, in the context of the present patent application, to have particular implications with respect to the one or more signals being communicated, such as, for example, whether the signals are being communicated “to” a particular device, whether the signals are being communicated “from” a particular device, and/or regarding which end of a communication path may be initiating communication, such as, for example, in a “push type” of signal transfer or in a “pull type” of signal transfer. In the context of the present patent application, push and/or pull type signal transfers are distinguished by which end of a communications path initiates signal transfer.

In the context of the particular patent application, a network protocol, such as for communicating between devices of a network, may be characterized, at least in part, substantially in accordance with a layered description, such as the so-called Open Systems Interconnection (OSI) seven layer type of approach and/or description. A network computing and/or communications protocol (also referred to as a network protocol) refers to a set of signaling conventions, such as for communication transmissions, for example, as may take place between and/or among devices in a network. In the context of the present patent application, the term “between” and/or similar terms are understood to include “among” if appropriate for the particular usage and vice-versa. Likewise, in the context of the present patent application, the terms “compatible with,” “comply with” and/or similar terms are understood to respectively include substantial compatibility and/or substantial compliance.

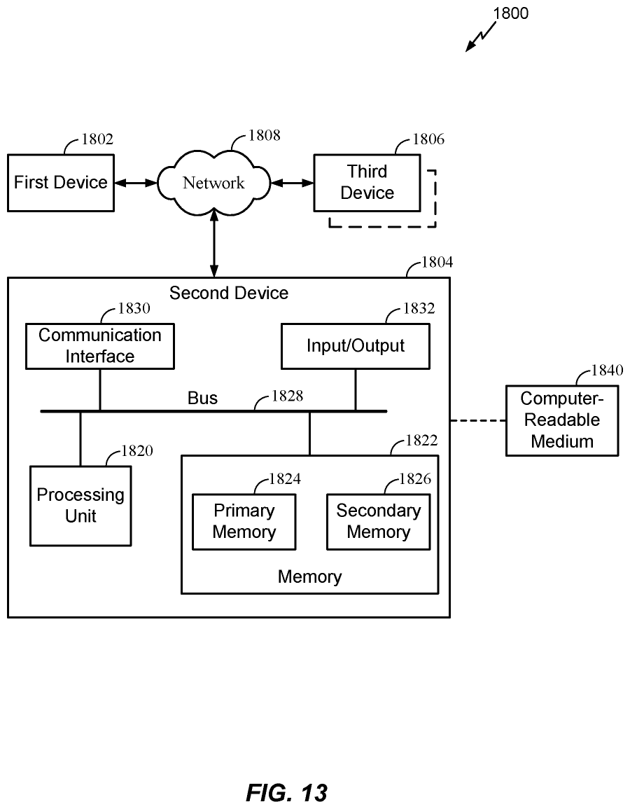

In one example embodiment, as shown in FIG. 13, a system embodiment may comprise a local network (e.g., device 1804 and medium 1840) and/or another type of network, such as a computing and/or communications network. For purposes of illustration, therefore, FIG. 13 shows an embodiment 1800 of a system that may be employed to implement either type or both types of networks. Network 1808 may comprise one or more network connections, links, processes, services, applications, and/or resources to facilitate and/or support communications, such as an exchange of communication signals, for example, between a computing device, such as 1802, and another computing device, such as 1806, which may, for example, comprise one or more client computing devices and/or one or more server computing device. By way of example, but not limitation, network 1808 may comprise wireless and/or wired communication links, telephone and/or telecommunications systems, Wi-Fi networks, Wi-MAX networks, the Internet, a local area network (LAN), a wide area network (WAN), or any combinations thereof.

Example devices in FIG. 13 may comprise features, for example, of a client computing device and/or a server computing device, in an embodiment. It is further noted that the term computing device, in general, whether employed as a client and/or as a server, or otherwise, refers at least to a processor and a memory connected by a communication bus. A “processor” and/or “processing circuit” for example, is understood to connote a specific structure such as a central processing unit (CPU), digital signal processor (DSP), graphics processing unit (GPU), image signal processor (ISP) and/or neural network processing unit (NPU), or a combination thereof, of a computing device which may include a control unit and an execution unit. In an aspect, a processor and/or processing circuit may comprise a device that fetches, interprets and executes instructions to process input signals to provide output signals. As such, in the context of the present patent application at least, this is understood to refer to sufficient structure within the meaning of 35 USC § 112 (f) so that it is specifically intended that 35 USC § 112 (f) not be implicated by use of the term “computing device,” “processor,” “processing unit,” “processing circuit” and/or similar terms; however, if it is determined, for some reason not immediately apparent, that the foregoing understanding cannot stand and that 35 USC § 112 (f), therefore, necessarily is implicated by the use of the term “computing device” and/or similar terms, then, it is intended, pursuant to that statutory section, that corresponding structure, material and/or acts for performing one or more functions be understood and be interpreted to be described at least in FIGS. 9A through 12 and in the text associated with the foregoing figure(s) of the present patent application.

Referring now to FIG. 13, in an embodiment, first and third devices 1802 and 1806 may be capable of rendering a graphical user interface (GUI) for a network device and/or a computing device, for example, so that a user-operator may engage in system use. Device 1804 may potentially serve a similar function in this illustration. Likewise, in FIG. 13, computing device 1802 (‘first device’ in figure) may interface with computing device 1804 (‘second device’ in figure), which may, for example, also comprise features of a client computing device and/or a server computing device, in an embodiment. Processor (e.g., processing device) 1820 and memory 1822, which may comprise primary memory 1824 and secondary memory 1826, may communicate by way of a communication bus 1815, for example. The term “computing device,” in the context of the present patent application, refers to a system and/or a device, such as a computing apparatus, that includes a capability to process (e.g., perform computations) and/or store digital content, such as electronic files, electronic documents, measurements, text, images, video, audio, etc. in the form of signals and/or states. Thus, a computing device, in the context of the present patent application, may comprise hardware, software, firmware, or any combination thereof (other than software per se). Computing device 1804, as depicted in FIG. 13, is merely one example, and claimed subject matter is not limited in scope to this particular example. FIG. 13 may further comprise a communication interface 1830 which may comprise circuitry and/or devices to facilitate transmission of messages between second device 1804 and first device 1802 and/or third device 1806 in a physical transmission medium over network 1808 using one or more network communication techniques identified herein, for example. In a particular implementation, communication interface 1830 may comprise a transmitter device including devices and/or circuitry to modulate a physical signal in physical transmission medium according to a particular communication format based, at least in part, on a message that is intended for receipt by one or more recipient devices. Similarly, communication interface 1830 may comprise a receiver device comprising devices and/or circuitry demodulate a physical signal in a physical transmission medium to, at least in part, recover at least a portion of a message used to modulate the physical signal according to a particular communication format. In a particular implementation, communication interface may comprise a transceiver device having circuitry to implement a receiver device and transmitter device.

For one or more embodiments, a device, such as a computing device and/or networking device, may comprise, for example, any of a wide range of digital electronic devices, including, but not limited to, desktop and/or notebook computers, high-definition televisions, digital versatile disc (DVD) and/or other optical disc players and/or recorders, game consoles, satellite television receivers, cellular telephones, tablet devices, wearable devices, personal digital assistants, mobile audio and/or video playback and/or recording devices, Internet of Things (IoT) type devices, or any combination of the foregoing. Further, unless specifically stated otherwise, a process as described, such as with reference to flow diagrams and/or otherwise, may also be executed and/or affected, in whole or in part, by a computing device and/or a network device. A device, such as a computing device and/or network device, may vary in terms of capabilities and/or features. Claimed subject matter is intended to cover a wide range of potential variations. For example, a device may include a numeric keypad and/or other display of limited functionality, such as a monochrome liquid crystal display (LCD) for displaying text, for example. In contrast, however, as another example, a web-enabled device may include a physical and/or a virtual keyboard, mass storage, one or more accelerometers, one or more gyroscopes, GNSS receiver and/or other location-identifying type capability, and/or a display with a higher degree of functionality, such as a touch-sensitive color 5D or 3D display, for example.

In FIG. 13, computing device 1802 may provide one or more sources of executable computer instructions in the form physical states and/or signals (e.g., stored in memory states), for example. Computing device 1802 may communicate with computing device 1804 by way of a network connection, such as via network 1808, for example. As previously mentioned, a connection, while physical, may not necessarily be tangible. Although computing device 1804 of FIG. 16 shows various tangible, physical components, claimed subject matter is not limited to a computing devices having only these tangible components as other implementations and/or embodiments may include alternative arrangements that may comprise additional tangible components or fewer tangible components, for example, that function differently while achieving similar results. Rather, examples are provided merely as illustrations. It is not intended that claimed subject matter be limited in scope to illustrative examples.

Memory 1822 may comprise any non-transitory storage mechanism. Memory 1822 may comprise, for example, primary memory 1824 and secondary memory 1826, additional memory circuits, mechanisms, or combinations thereof may be used. Memory 1822 may comprise, for example, random access memory, read only memory, etc., such as in the form of one or more storage devices and/or systems, such as, for example, a disk drive including an optical disc drive, a tape drive, a solid-state memory drive, etc., just to name a few examples.

Memory 1822 may be utilized to store a program of executable computer instructions. For example, processor 1820 may fetch executable instructions from memory and proceed to execute the fetched instructions. Memory 1822 may also comprise a memory controller for accessing device readable-medium 1840 that may carry and/or make accessible digital content, which may include code, and/or instructions, for example, executable by processor 1820 and/or some other device, such as a controller, as one example, capable of executing computer instructions, for example. Under direction of processor 1820, a non-transitory memory, such as memory cells storing physical states (e.g., memory states), comprising, for example, a program of executable computer instructions, may be executed by processor 1820 and able to generate signals to be communicated via a network, for example, as previously described. Generated signals may also be stored in memory, also previously suggested.

Memory 1822 may store electronic files and/or electronic documents, such as relating to one or more users, and may also comprise a computer-readable medium that may carry and/or make accessible content, including code and/or instructions, for example, executable by processor 1820 and/or some other device, such as a controller, as one example, capable of executing computer instructions, for example. As previously mentioned, the term electronic file and/or the term electronic document are used throughout this document to refer to a set of stored memory states and/or a set of physical signals associated in a manner so as to thereby form an electronic file and/or an electronic document. That is, it is not meant to implicitly reference a particular syntax, format and/or approach used, for example, with respect to a set of associated memory states and/or a set of associated physical signals. It is further noted an association of memory states, for example, may be in a logical sense and not necessarily in a tangible, physical sense. Thus, although signal and/or state components of an electronic file and/or electronic document, are to be associated logically, storage thereof, for example, may reside in one or more different places in a tangible, physical memory, in an embodiment.

Algorithmic descriptions and/or symbolic representations are examples of techniques used by those of ordinary skill in the signal processing and/or related arts to convey the substance of their work to others skilled in the art. An algorithm is, in the context of the present patent application, and generally, is considered to be a self-consistent sequence of operations and/or similar signal processing leading to a desired result. In the context of the present patent application, operations and/or processing involve physical manipulation of physical quantities. Typically, although not necessarily, such quantities may take the form of electrical and/or magnetic signals and/or states capable of being stored, transferred, combined, compared, processed and/or otherwise manipulated, for example, as electronic signals and/or states making up components of various forms of digital content, such as signal measurements, text, images, video, audio, etc.

It has proven convenient at times, principally for reasons of common usage, to refer to such physical signals and/or physical states as bits, values, elements, parameters, symbols, characters, terms, samples, observations, weights, numbers, numerals, measurements, content and/or the like. It should be understood, however, that all of these and/or similar terms are to be associated with appropriate physical quantities and are merely convenient labels. Unless specifically stated otherwise, as apparent from the preceding discussion, it is appreciated that throughout this specification discussions utilizing terms such as “processing,” “computing,” “calculating,” “determining”, “establishing”, “obtaining”, “identifying”, “selecting”, “generating”, and/or the like may refer to actions and/or processes of a specific apparatus, such as a special purpose computer and/or a similar special purpose computing and/or network device. In the context of this specification, therefore, a special purpose computer and/or a similar special purpose computing and/or network device is capable of processing, manipulating and/or transforming signals and/or states, typically in the form of physical electronic and/or magnetic quantities, within memories, registers, and/or other storage devices, processing devices, and/or display devices of the special purpose computer and/or similar special purpose computing and/or network device. In the context of this particular patent application, as mentioned, the term “specific apparatus” therefore includes a general purpose computing and/or network device, such as a general purpose computer, once it is programmed to perform particular functions, such as pursuant to program software instructions.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and/or storage of charge or a release of stored charge. Likewise, in other memory devices, a change of state may comprise a physical change, such as a transformation in magnetic orientation. Likewise, a physical change may comprise a transformation in molecular structure, such as from crystalline form to amorphous form or vice-versa. In still other memory devices, a change in physical state may involve quantum mechanical phenomena, such as, superposition, entanglement, and/or the like, which may involve quantum bits (qubits), for example. The foregoing is not intended to be an exhaustive list of all examples in which a change in state from a binary one to a binary zero or vice-versa in a memory device may comprise a transformation, such as a physical, but non-transitory, transformation. Rather, the foregoing is intended as illustrative examples.

Referring again to FIG. 13, processor 1820 may comprise one or more circuits, such as digital circuits, to perform at least a portion of a computing procedure and/or process. By way of example, but not limitation, processor 1820 may comprise one or more processors, such as controllers, microprocessors, microcontrollers, application specific integrated circuits, digital signal processors (DSPs), graphics processing units (GPUs), neural network processing units (NPUs), image signal processors (ISPs), programmable logic devices, field programmable gate arrays, the like, or any combination thereof. In various implementations and/or embodiments, processor 1820 may perform signal processing, typically substantially in accordance with fetched executable computer instructions, such as to manipulate signals and/or states, to construct signals and/or states, etc., with signals and/or states generated in such a manner to be communicated and/or stored in memory, for example.

FIG. 13 also illustrates device 1804 as including a component 1832 operable with input/output devices, for example, so that signals and/or states may be appropriately communicated between devices, such as device 1804 and an input device and/or device 1804 and an output device. A user may make use of an input device, such as a computer mouse, stylus, track ball, keyboard, and/or any other similar device capable of receiving user actions and/or motions as input signals. Likewise, for a device having speech to text capability, a user may speak to a device to generate input signals. A user may make use of an output device, such as a display, a printer, etc., and/or any other device capable of providing signals and/or generating stimuli for a user, such as visual stimuli, audio stimuli and/or other similar stimuli.

One particular embodiment disclosed herein is directed to an article comprising: a storage medium comprising computer-readable instructions stored thereon that are executable by one or more processors of a computing device to: convolve image signal intensity values associated with at least a portion of pixel locations in an image frame with kernel coefficients to provide an output image signal intensity value mapped to an output pixel location in the image frame, wherein: kernel coefficients to be applied to image signal intensity values for pixels in a first region of the at least a portion of pixel locations in the image frame to be selected from a set of coefficient values such that the same coefficient value is to be applied to image signal intensity values of multiple pixel locations in the first region. In one particular implementation, pixel locations in the first region are mapped to the same coefficient value of the set of coefficient values based, at least in part, on full-granularity coefficient values computed for the pixel locations in the first region. For example, the same coefficient value is computed based, at least in part, on full-granularity coefficient values including at least some of the full-granularity coefficient values computed for the pixel locations. In another example, the same coefficient value is computed as an average of the full-granularity coefficient values. In yet another example, the pixel locations in the first region are mapped to the same coefficient value based, at least in part, on an association of the full-granularity coefficient values with a range of values including the same coefficient value. In another particular implementation, the same coefficient value is selected to be applied to the image signal intensity values of the multiple pixel locations based, at least in part, a location of the first region relative to the output pixel location. For example, the first region may be peripheral to a second region the at least a portion of pixel locations in the image frame, the second region containing the output pixel location. In another example, the first region may be at a vertical periphery to the second region; a single kernel coefficient may be applied to image signal intensity values of multiple pixel locations in the first region extending in a vertical direction; and kernel coefficients may be applied with full granularity in a horizontal dimension. In yet another example, the first region may be at a lateral periphery to the second region; a single kernel coefficient may be applied to image signal intensity values of multiple pixel locations in the first region extending in a horizontal direction; and kernel coefficients may be applied with full granularity in a vertical dimension. In yet another particular implementation, convolution of image signal intensity values associated with pixel locations in the first region may comprise: computation of a sum of image signal intensity values associated with two or more pixel locations in the first region; computation of a product of the summed image signal intensity values by the same coefficient value; and determination of the output image signal intensity value based, at least in part, on the computed product. In yet another particular implementation, the instructions may be further executable by the one or more processors to: map image signal intensity values for at least some pixel locations in the region of the image frame to a single image signal intensity value; multiply the signal image signal value by a coefficient value selected from the set of coefficient values to compute a product; and determine the output image signal intensity value based, at least in part on the computed product. For example, the instructions may be executable to average the image signal intensity values to obtain the map. In another particular implementation, the instructions are further executable by the one or more processors to select between and/or among multiple modes to convolve the image signal intensity values associated with the at least a portion of pixel locations in the image frame, the multiple modes to convolve including at least a first mode comprising application of the same coefficient value to image signal intensity values of the multiple pixel locations in the first region. For example, the multiple modes to convolve may further includes a second mode comprising skipping image signal intensity values in the color channel for at least some pixel locations in the first region.

Another particular embodiment disclosed herein is directed to an apparatus comprising: a memory storage device; one or more processors coupled to the memory storage device, the one or more processors to: convolve image signal intensity values associated with at least a portion of pixel locations in an image frame with kernel coefficients to provide an output image signal intensity value mapped to an output pixel location in the image frame, wherein: kernel coefficients to be applied to image signal intensity values for pixels in a first region of the at least a portion of pixel locations in the image frame to be selected from a set of coefficient values such that the same coefficient value is to be applied to image signal intensity values of multiple pixel locations in the first region. In one particular implementation, pixel locations in the first region are mapped to the same coefficient value of the set of coefficient values based, at least in part, on full-granularity coefficient values computed for the pixel locations in the first region. For example, the same coefficient value is computed based, at least in part, on full-granularity coefficient values including at least some of the full-granularity coefficient values computed for the pixel locations. In another example, the same coefficient value is computed as an average of the full-granularity coefficient values. In yet another example, the pixel locations in the first region are mapped to the same coefficient value based, at least in part, on an association of the full-granularity coefficient values with a range of values including the same coefficient value. In another particular implementation, the same coefficient value is selected to be applied to the image signal intensity values of the multiple pixel locations based, at least in part, a location of the first region relative to the output pixel location. For example, the first region may be peripheral to a second region the at least a portion of pixel locations in the image frame, the second region containing the output pixel location. In another example, the first region may be at a vertical periphery to the second region; a single kernel coefficient may be applied to image signal intensity values of multiple pixel locations in the first region extending in a vertical direction; and kernel coefficients may be applied with full granularity in a horizontal dimension. In yet another example, the first region may be at a lateral periphery to the second region; a single kernel coefficient may be applied to image signal intensity values of multiple pixel locations in the first region extending in a horizontal direction; and kernel coefficients may be applied with full granularity in a vertical dimension. In yet another particular implementation, convolution of image signal intensity values associated with pixel locations in the first region may comprise: computation of a sum of image signal intensity values associated with two or more pixel locations in the first region; computation of a product of the summed image signal intensity values by the same coefficient value; and determination of the output image signal intensity value based, at least in part, on the computed product. In yet another particular implementation, the one or more processors are further to: map image signal intensity values for at least some pixel locations in the region of the image frame to a single image signal intensity value; multiply the signal image signal value by a coefficient value selected from the set of coefficient values to compute a product; and determine the output image signal intensity value based, at least in part on the computed product. For example, the one or more processors may be further to average the image signal intensity values to obtain the map. In another particular implementation, the one or more processors may be further to select between and/or among multiple modes to convolve the image signal intensity values associated with the at least a portion of pixel locations in the image frame, the multiple modes to convolve including at least a first mode comprising application of the same coefficient value to image signal intensity values of the multiple pixel locations in the first region. For example, the multiple modes to convolve may further includes a second mode comprising skipping image signal intensity values in the color channel for at least some pixel locations in the first region.

Yet another particular embodiment disclosed herein is directed to an article comprising: a storage medium comprising computer-readable instructions stored thereon that are executable by one or more processors of a computing device to: map original image signal intensity values of a plurality of contiguous pixel locations in a portion of an image frame to a single image signal intensity value to be representative of the contiguous pixel locations in an augmented portion of the image frame; and convolve image signal intensity values associated with pixel locations in the augmented portion of the image frame by applying one or more kernel coefficients to the image signal intensity values pixel locations associated with the pixel locations in the augmented portion of the image frame. In one particular implementation, the instructions are further executable the one or more processors to determine the single image signal intensity value based, at least in part, on an average of the original image signal intensity values. For example, the instructions may be further executable the one or more processors to determine the single image signal intensity value based, at least in part, on selection of a representative image signal intensity value from among the original image signal intensity values. In yet another particular implementation, kernel coefficients to be applied to image signal intensity values for pixels in the augmented portion of the image frame may be selected from a set of coefficient values such that the same coefficient value is to be applied to image signal intensity values of multiple pixel locations in the augmented portion of the image frame.

Yet another particular embodiment disclosed herein is directed to an apparatus comprising: a memory storage device; one or more processors coupled to the memory storage device, the one or more processors to: map original image signal intensity values of a plurality of contiguous pixel locations in a portion of an image frame to a single image signal intensity value to be representative of the contiguous pixel locations in an augmented portion of the image frame; and convolve image signal intensity values associated with pixel locations in the augmented portion of the image frame by applying one or more kernel coefficients to the image signal intensity values pixel locations associated with the pixel locations in the augmented portion of the image frame. In one particular implementation, the instructions are further executable the one or more processors to determine the single image signal intensity value based, at least in part, on an average of the original image signal intensity values. For example, the instructions may be further executable the one or more processors to determine the single image signal intensity value based, at least in part, on selection of a representative image signal intensity value from among the original image signal intensity values. In yet another particular implementation, kernel coefficients to be applied to image signal intensity values for pixels in the augmented portion of the image frame may be selected from a set of coefficient values such that the same coefficient value is to be applied to image signal intensity values of multiple pixel locations in the augmented portion of the image frame.

Yet another particular embodiment disclosed herein is directed to an apparatus comprising: a memory storage device; one or more processors coupled to the memory storage device, the one or more processors to: map original image signal intensity values of a plurality of contiguous pixel locations in a portion of an image frame to a single image signal intensity value to be representative of the contiguous pixel locations in an augmented portion of the image frame; and convolve image signal intensity values associated with pixel locations in the augmented portion of the image frame by applying one or more kernel coefficients to the image signal intensity values pixel locations associated with the pixel locations in the augmented portion of the image frame. In one particular implementation, the instructions are further executable the one or more processors to determine the single image signal intensity value based, at least in part, on an average of the original image signal intensity values. For example, the instructions may be further executable the one or more processors to determine the single image signal intensity value based, at least in part, on selection of a representative image signal intensity value from among the original image signal intensity values. In yet another particular implementation, kernel coefficients to be applied to image signal intensity values for pixels in the augmented portion of the image frame may be selected from a set of coefficient values such that the same coefficient value is to be applied to image signal intensity values of multiple pixel locations in the augmented portion of the image frame.

In the preceding description, various aspects of claimed subject matter have been described. For purposes of explanation, specifics, such as amounts, systems and/or configurations, as examples, were set forth. In other instances, well-known features were omitted and/or simplified so as not to obscure claimed subject matter.

While certain features have been illustrated and/or described herein, many modifications, substitutions, changes and/or equivalents will now occur to those skilled in the art. It is, therefore, to be understood that the appended claims are intended to cover all modifications and/or changes as fall within claimed subject matter.

What is claimed is:

1. A method comprising:
convolving image signal intensity values associated with at least a portion of pixel locations in an image frame with kernel coefficients to provide an output image signal intensity value mapped to an output pixel location in the image frame, wherein:
kernel coefficients to be applied to image signal intensity values for pixels in a first region of the at least a portion of pixel locations in the image frame are selected from a set of coefficient values such that a same coefficient value is to be applied to image signal intensity values of multiple pixel locations in the first region.

2. The method of claim 1, wherein:
pixel locations in the first region are mapped to the same coefficient value of the set of coefficient values based, at least in part, on full-granularity coefficient values computed for the pixel locations in the first region.

3. The method of claim 2, wherein the same coefficient value is computed based, at least in part, on full-granularity coefficient values including at least some of the full-granularity coefficient values computed for the pixel locations.

4. The method of claim 2, wherein the same coefficient value is computed as an average of the full-granularity coefficient values.

5. The method of claim 2, wherein the pixel locations in the first region are mapped to the same coefficient value based, at least in part, on an association of the full-granularity coefficient values with a range of values including the same coefficient value.

6. The method of claim 1, wherein: the same coefficient value is selected to be applied to the image signal intensity values of the multiple pixel locations based, at least in part, a location of the first region relative to the output pixel location.

7. The method of claim 6, wherein the first region is peripheral to a second region the at least a portion of pixel locations in the image frame, the second region containing the output pixel location.

8. The method of claim 7, wherein:
the first region is at a vertical periphery to the second region;
a single kernel coefficient is applied to image signal intensity values of multiple pixel locations in the first region extending in a vertical direction; and
kernel coefficients are applied with full granularity in a horizontal dimension.

9. The method of claim 7, wherein:
the first region is at a lateral periphery to the second region;
a single kernel coefficient is applied to image signal intensity values of multiple pixel locations in the first region extending in a horizontal direction; and
kernel coefficients are applied with full granularity in a vertical dimension.

10. The method of claim 1, wherein convolving image signal intensity values associated with pixel locations in the first region comprises:
summing image signal intensity values associated with two or more pixel locations in the first region;
multiplying the summed image signal intensity values by the same coefficient value to compute a product; and
determining the output image signal intensity value based, at least in part, on the computed product.

11. The method of claim 1, and further comprising:
mapping image signal intensity values for at least some pixel locations in a second region of the image frame to a single image signal intensity value;
multiplying the single image signal intensity value by a coefficient value selected from the set of coefficient values to compute a product; and
determining the output image signal intensity value based, at least in part on the computed product.

12. The method of claim 11, wherein mapping the image signal intensity values comprises averaging the image signal intensity values.

13. The method of claim 1, and further comprising:
selecting between and/or among multiple modes to convolve the image signal intensity values associated with the at least a portion of pixel locations in the image frame, the multiple modes to convolve including at least a first mode comprising application of the same coefficient value to image signal intensity values of the multiple pixel locations in the first region.

14. The method of claim 1, wherein the same coefficient value is selected to be a reduced granularity coefficient value or a reduced precision value based, at least in part, on a location of the first region relative to the output pixel location.

15. A method comprising:
mapping original image signal intensity values of a plurality of pixel locations in a portion of an image frame to a single image signal intensity value to be representative of the pixel locations in an augmented portion of the image frame; and
convolving image signal intensity values associated with the plurality of pixel locations in the augmented portion of the image frame by applying one or more kernel coefficients to the single image signal intensity value.

16. The method of claim 15, and further comprising determining the single image signal intensity value based, at least in part, on an average of the original image signal intensity values.

17. The method of claim 16, and further comprising determining the single image signal intensity value based, at least in part, on selection of a representative image signal intensity value from among the original image signal intensity values.

18. The method of claim 15, wherein:
kernel coefficients to be applied to image signal intensity values for pixels in the augmented portion of the image frame are selected from a set of coefficient values such that a same coefficient value is to be applied to image signal intensity values of multiple pixel locations in the augmented portion of the image frame.

19. The method of claim 15, wherein:
the image frame comprises a multi-color channel image frame; and
the plurality of pixel locations in the augmented portion of the image frame are dis-contiguous and associated with a same color channel.

20. The method of claim 16, wherein the original image signal intensity values of the plurality of pixel locations are mapped to the single image intensity value and the one or more kernel coefficients are applied to the single image signal intensity value responsive to a mode configured at runtime.

21. An apparatus comprising:
a memory storage device;
one or more processors coupled to the memory storage device, the one or more processors to:
convolve image signal intensity values associated with at least a portion of pixel locations in an image frame with kernel coefficients to provide an output image signal intensity value mapped to an output pixel location in the image frame, wherein:
kernel coefficients to be applied to image signal intensity values for pixels in a first region of the at least a portion of pixel locations in the image frame to be selected from a set of coefficient values such that a same coefficient value is to be applied to image signal intensity values of multiple pixel locations in the first region.
